(19) United States
(12) Patent Application Publication
(10) Pub. No.: US 2025/0037690 A1
(43) Pub. Date: Jan. 30, 2025

(54) MATCHING LAYER FOR ACOUSTIC TRANSDUCER

(71) Applicant: The Penn State Research Foundation, University Park, PA (US)

(72) Inventors: Sri-Rajasekhar Kothapalli, University Park, PA (US); Ajay Dangi, University Park, PA (US); Sumit Agrawal, University Park, PA (US)

(21) Appl. No.: 18/793,671

(22) Filed: Aug. 2, 2024

Related U.S. Application Data
(63) Continuation-in-part of application No. 17/429,453, filed on Aug. 9, 2021.
(60) Provisional application No. 63/517,309, filed on Aug. 2, 2023.
(60) Provisional application No. 62/803,797, filed on Feb. 11, 2019.

(51) Int. Cl. G10K 11/02; G01N 29/06; G01N 29/24

(52) U.S. Cl. CPC G10K 11/02; G01N 29/0681; G01N 29/2437; G01N 2291/101

(57) ABSTRACT

A matching layer for an ultrasound imaging head includes a translucent matrix and a plurality of translucent particles (e.g, glass beads, etc.) disposed in the translucent matrix. A volume fraction of the plurality of translucent glass beads in the translucent matrix is selected to provide a predetermined acoustic impedance. The diameter of the glass beads of the plurality of glass beads may be selected to provide a predetermined acoustic impedance. The matching layer may be disposed on a transparent piezoelectric element. Such an arrangement may be configured for photoacoustic imaging. An illumination source may provide light to a region of interest, and the light may be transmitted at least partially through the transparent piezoelectric element and the matching layer.

### CROSS-REFERENCE TO RELATED APPLICATIONS

This application claims the benefit of U.S. Provisional Application No. 63/517,309, filed on Aug. 2, 2023, now pending, and is a continuation-in-part of U.S. patent application Ser. No. 17/429,453, filed on Aug. 9, 2021, now pending, which is national stage application, filed under 35 U.S.C. § 371, of International Patent Application No. PCT/US2020/017793, filed on Feb. 11, 2020, which claims the benefit of U.S. Provisional Patent Application No. 62/803,797, filed on Feb. 11, 2019, each of which is incorporated by reference herein in its entirety.

### STATEMENT REGARDING FEDERALLY SPONSORED RESEARCH

This invention was made with government support under Grant No. EB017729 awarded by the National Institutes of Health. The Government has certain rights in the invention.

### FIELD OF THE DISCLOSURE

The present disclosure relates to ultrasonic imaging, and more particularly to acoustic coupling media used to couple an imaging head (e.g., a transducer) to the object to be imaged (e.g., biological tissue) and a transducer including the coupling media.

### BACKGROUND OF THE DISCLOSURE

Over the past decade, dual-modality ultrasound and photoacoustic (USPA) imaging has evolved as a noninvasive biomedical imaging modality capable of displaying both ultrasound based anatomical contrast and photoacoustic imaging (PAI) based optical absorption contrast of deep tissue in real-time. In PAI, nanosecond pulsed laser illuminates the soft tissue causing thermoelastic expansion and wideband ultrasound generation from light absorbing chromophores. These photoacoustic waves propagate through the tissue and detected by acoustic transducers coupled to the biological subject and analyzed to produce ultrasound and photoacoustic images in real-time. The USPA imaging modality has been translated into several preclinical and clinical studies. In particular, label-free PAI of vasculature and associated oxygen saturation, melanin and lipids have shown promise for diagnosing cancer, orthopedic, neurological, and vascular diseases.

A dual-modality USPA imaging device is achieved by attaching two light guides on either side of a conventional ultrasound transducer probe, because standard ultrasound transducer arrays are not transparent to light. This complex arrangement not only leads to a bulky imaging head, but also forms a light offset region (shadow illumination) up to 2 cm depth below the transducer as shown in FIG. TA. While conventional ultrasound imaging devices are directly coupled to the tissue with a small amount ultrasound gel on the skin surface, the USPA imaging head cannot be directly coupled to the tissue as this would result in low light within the ultrasound imaging plane. To partially offset this problem, in conventional USPA imaging, the imaging head is placed 1 cm to 2 cm (this distance depends on the transducer aperture size) away from the tissue surface to help co-align light into the ultrasound imaging plane. This large gap between the transducer and the tissue surface is filled with an acoustic coupling medium such as water or ultrasound gel. Therefore, directing light around the conventional transducer probe leads to a bulky imaging head which requires significant acoustic coupling. These issues generate several problems for real-time and hand-held USPA imaging in pre-clinical and clinical applications. For example, a large acoustic coupling medium: (i) introduces extra travel distance for both ultrasound and photoacoustic imaging, thereby limiting the imaging speed, which is critical for certain high frame rate applications; (ii) brings discomfort to the living subject during imaging sessions which typically takes a minimum of 30 minutes; (iii) restricts easy movement of the imaging head on the tissue surface; and (iv) introduces artifacts due to bubble formation inside the coupling medium, especially when the imaging head is moved from one position to another position.

To address the above issues, different USPA imaging geometries have been investigated for co-axial arrangement of light illumination and ultrasound paths. In one geometry, an ultrasound probe and light illuminating fiber bundle were kept perpendicular to each other and an optically transparent acoustic reflector was used to directly transmit the light and reflect the ultrasound waves. In order simplify this configuration, a second acoustic reflector was added to reflect acoustic signals by another 90°, which allowed a parallel arrangement between the fiber bundle and the ultrasound probe. Despite these developments, imaging heads are still not compact enough for free hand-held movement and require significant acoustic coupling to the tissue. To overcome these difficulties arising due to opaque conventional ultrasound transducer arrays, optically transparent ultrasound transducers (TUTs) have been developed by various research groups. TUTs facilitated natural co-axial alignment of light illumination and photoacoustic detection without inducing shadow regions. TUTs were developed using different materials and fabrication procedures. One class of TUTs are fabricated using transparent capacitance micromachined ultrasound transducer (CMUT) approach. But transparent CMUTs suffer from drawbacks such as complex fabrication processes, large bias voltage, and custom-developed integrated circuits for operation. Recently, conventional piezoelectric materials such as transparent lithium niobate (LN), lead magnesium niobate-lead titanate (PMN-PT), and polyvinylidene fluoride (PVDF) are being actively used in TUT fabrication as they are easy to manufacture using standard machine tools. Our group demonstrated LN based TUT (LN-TUT) for different PAI applications, such as optical-resolution photoacoustic-microscopy (OR-PAM) by scanning focused laser spot through a planar single element LN-TUT window as shown in FIG. 1B and real-time USPA imaging by sending collimated beam through a LN-TUT array as shown in FIG. 1C.

These prior results demonstrated that LN-TUTs (i) exhibit up to 80% optical transparency in the visible and near-infrared wavelength regions; (ii) require only a thin layer of acoustic coupling; (iii) can generate in vivo OR-PAM images of mouse brain with high spatial resolution and contrast; and (iv) enable multimodal ultrasound, photoacoustic, and Doppler US images when using TUT arrays. However, the TUTs commonly suffer from low-sensitivity and low-bandwidth (˜15% pulse-echo bandwidth and ˜20% photoacoustic bandwidth) due to the lack of proper acoustic matching and backing layers. In conventional ultrasound transducer fabrication, a matching layer is formed using alumina powder mixed in epoxy, whereas a backing layer is formed using tungsten particles suspended in epoxy. Because these materials are not transparent to light, they are not useful for TUT development. Transparent or translucent particles with suitable acoustic properties are ideally needed in the fabrication of matching and backing layers of TUTs.

### BRIEF SUMMARY OF THE DISCLOSURE

To address the above shortcomings, the present disclosure provides a matching layer design for the TUTs. Using both simulations and experiments, we studied the feasibility of different volume fractions of glass beads (e.g., silicon dioxide/silica SiO₂) suspended in transparent epoxy (GB) to serve as both acoustic matching layer and optical scattering layer. Electrical, acoustic, optical, and photoacoustic characterization was performed to find optimal GB concentration matching layer for the 13 MHz center frequency LN-TUTs. The presently disclosed GB matching layer enhanced both the acoustic sensitivity and detection bandwidth of LN-TUTs while allowing uniform distribution of light on the tissue surface for shadow-free PA imaging, as seen in FIG. 1D. FIG. 2 shows the comparison between the optical transmission between Nittany Lion mascot picture with and without GB sheet.

The presently disclosed glass bead (“GB”) matching layer provides outstanding acoustic properties while demonstrating its capability for uniform light scattering. An example GB matching layer improved photoacoustic and pulse-echo bandwidth by 139% and 228% with 40% GB ratio, and the peak-to-peak pulse-echo amplitude by 2.16 folds. A light scattering experiment showed that both 40% and 60% GB matching layers exhibited uniform light fluence distribution with the commercial grounded diffuser glass with reasonable light transmittance. Additionally, adding a GB matching layer to a TUT provided the enhanced acoustic coupling to match the piezoelectric material with the tissue medium while optimizing light delivery through light diffusion.

### DESCRIPTION OF THE DRAWINGS

For a fuller understanding of the nature and objects of the disclosure, reference should be made to the following detailed description taken in conjunction with the accompanying drawings.

FIG. 1. A comparison of the light illumination of the conventional and proposed USPA imaging systems: (A) A side-view schematic of the conventional USPA systems, (B) A side-view schematic of the coaxial alignment offered by the TUT for optical-resolution photoacoustic-microscopy (OR-PAM) systems, (C) A side-view schematic of the coaxial alignment offered by the TUT for USPA systems, (D) A side-view schematic of the light illumination through the GB-TUT for USPA systems. LN: Lithium Niobate, LO: Light Offset, M. L.: Matching Layer.

FIG. 2. A photograph of Penn State logo: (A) In the free space, (B) Through 40% volume fraction GB sheet with quarter wavelength 60 μm thickness.

FIG. 3. Front view schematics of the setup used to measure the speed of sound inside the GB block. Where T₁ and T₂ are the measured time difference of the signal being transmitted and received back by the transducer (A) with and (B) without the GB block respectively. UST: Ultrasound Transducer, DI water: Deionized water.

FIG. 4. Variation of (A) density, (B) acoustic impedance, (C) longitudinal speed of sound, and (D) acoustic attenuation, as a function of the volume fraction of glass beads in transparent epoxy (GB). Devaney and Levine model theoretical simulation (Sim.) are plotted with dashed lines in black and experimental results (Exp.) are presented as black scattered circles.

FIG. 5. Light distribution pattern and light transmission ratio of projected collimated laser light after passing through various volume fraction GB sheets and a commercial diffuser glass (DG). (A) Free space, (B) 15% GB sheet, (C) 40% GB sheet, (D) 60% GB sheet, (E) Commercial diffuser glass (DG). Light TR: Light Transmission Ratio.

FIG. 6. Experimental (Exp) and simulated (Sim) electrical impedance measurements of various volume fraction GB-TUTs. (A-D) Show the experimental electrical impedance response of 0%, 15%, 40%, and 60% GB-LN-TUTs, respectively. (E, F) Show the simulated electrical impedance response of 0%, and 40% GB-LN-TUTs, respectively.

FIG. 7. Experimental (Exp) and simulated (Sim) pulse-echo response of various volume fraction GB-LN-TUTs. (A-D) Show the experimental pulse echo response of 0%, 15%, 40%, and 60% GB-LN-TUTs, respectively. (E, F) Show the simulated pulse echo response of 0%, and 40% GB-LN-TUTs, respectively.

FIG. 8. Measured photoacoustic A-line responses from a pencil lead target placed at ˜3 mm depth using (A) 0% GB-LN-TUT, (B) 15% GB-LN-TUT, (C) 40% GB-LN-TUT, and (D) 60% GB-LN-TUT.

FIG. 9 is an illustration of a matching layer according to an embodiment of the present disclosure (the illustrations herein are not intended to accurately portray dimensions, volume fractions, etc.)

FIG. 10 is an illustration of a transducer according to an embodiment of the present disclosure.

FIG. 11 is an illustration of a transducer array according to an embodiment of the present disclosure.

FIG. 12A is a cross-sectional view of a device according to an embodiment of the present disclosure.

FIG. 12B is a cross-sectional view of a device according to another embodiment of the present disclosure.

FIG. 12C is a cross-sectional view of a device according to another embodiment of the present disclosure.

FIG. 13A is a diagram showing an optical fiber arranged with a single element transducer.

FIG. 13B is a diagram showing a light-emitting diode arranged with a single element transducer.

FIG. 13C is a diagram showing an array of light-emitting diodes arranged with a single element transducer.

FIG. 13D is a diagram showing an array of light-emitting diodes arranged with an array of transducers (i.e., a transducer having an array of elements).

FIG. 14 is a photograph of a device according to an embodiment of the present disclosure and having an optical fiber as a light source.

FIG. 15 is a graph depicting the percentage of light transmitted (transparency %) of an Indium-Tin-Oxide (ITO) coated 250 μm thick lithium niobate crystal measured in 690 nm to 970 nm range.

FIG. 16 is a graph depicting the ultrasound pulse-echo response and the frequency transform of an ultrasound echo of a transducer of an embodiment of the present disclosure.

FIG. 17 is a graph depicting pressure output of a device according to an embodiment of the present disclosure, where the distance from the ultrasound transducer is on the longitudinal axis.

FIG. 18 is a graph depicting the photoacoustic pulse response and the frequency transform of the pulse of a transducer of an embodiment of the present disclosure.

FIG. 19 is an image of a testing apparatus that includes a translucent photoacoustic imaging device according to the present disclosure, and a standard USAF test pattern.

FIG. 20 is a graph depicting the results of a linear photoacoustic scan conducted using the testing apparatus of FIG. 19.

FIG. 21 is an image of a photoacoustic imaging target formed by marking the characters “PSU” on a light-absorbing card and an illustration of a device of the present disclosure used to image the target.

FIG. 22 is an image resulting from raster scanning the target of FIG. 21 using the disclosed device.

FIG. 23 is a diagram of a device according to an embodiment of the present disclosure where an optical spot can be raster scanned through the translucent ultrasound transducer working as a stationary window.

FIG. 24 is an image resulting from raster scanning a letter “P” on a light absorbing card using a device as depicted in FIG. 23 where a 1 cm×1 cm transparent ultrasound transducer is used as the transparent window. Maximum amplitude projection photoacoustic image obtained from optical-only raster scanning over a letter ‘P’ marked on a black light absorbing card.

FIG. 25 illustrates a wearable form of the technology described herein where the transparent transducer can be vertically integrated with an array of light sources in a compact package and used for capturing human biometrics. Biometrics may be captured by, for example, co-registering ultrasound and photoacoustic image of fingerprints.

FIG. 26 illustrates a use of the technology for studying a rodent brain by monitoring its hemodynamic activity through vasculature imaging.

FIG. 27 illustrates a use of the technology incorporated into a smartphone for capturing biometrics to, for example, authenticate a user.

FIG. 28 illustrates a use of the technology described herein where the transparent ultrasound transducer can be used as a wearable patch and an optical beam can be raster scanned over the transparent window to generate a photoacoustic image.

FIG. 29A illustrates a prior art hand-held ultrasound imaging device that is adapted for combined ultrasound and photoacoustic imaging by integrating optical fibers to the device.

FIG. 29B describes a use of the transparent ultrasound technology described herein where the device can be made more efficient (e.g., without dark fields or shadows) and compact (not taking additional space for light) by providing the optical illumination through the transducer, for combined ultrasound and photoacoustic imaging.

FIG. 30 is a photograph of an optically transparent planar (10 mm×10 mm) lithium niobate substrate coated with ITO.

FIG. 31 is a block diagram representing a raster scan setup used for photoacoustic imaging using the transparent ultrasound transducer.

FIG. 32 is a graph of a photoacoustic pulse response of a transparent ultrasound transducer showing ˜6 mV amplitude from a light absorbing target. The frequency response of the photoacoustic pulse shows 14.5 MHz center frequency with ˜70% bandwidth.

FIG. 33 is a photograph showing photoacoustic imaging using the fiber-TUT device, wherein a linear photoacoustic scan was performed along a 6 cm long line covering line pairs of elements 2 to 6 in Group 2 of a USAF imaging resolution target.

FIG. 34 is a plot of peak photoacoustic amplitude along the linear scan with two points, P1 and P2, marked to estimate the resolution.

FIG. 35 is a schematic cross-sectional view of a TUT test embodiment, which had 10 mm height and 9×9 mm² field of view.

FIG. 36 is a photograph of a transducer of the test device of FIG. 35, clearly showing Nittany Lion mascot underneath.

FIG. 37 is a diagram of an optical-resolution photoacoustic-microscopy (OR-PAM) setup. Raster scanning achieved by Motor 1 moving Mirror 1 to perform x-axis scan. Motor 2 moved Mirror 2 and L3 to perform y-axis scan. BS: beam sampler; NDF: neutral density filter; PD: photodiode; PH: pinhole; L1, L2, L3: planoconvex lenses with 50, 75, and 50 mm focal lengths, respectively.

FIG. 38 are results of characterizing a test transparent lithium niobate ultrasound-transducer-based OR-PAM system. (a) Measured electrical impedance results; (b) Pulse-echo response; (c) Photoacoustic pulse response of USAF resolution test target; (d) Maximum-amplitude-projection (MAP) image of target via edge scanning. PA: photoacoustic; (e) Edge-response data and fitted line-spread-function (LSF) curve showed 8.5 μm lateral resolution. ESF: edge spread function; (f) Gaussian enveloped curve fitted profile showed 150 μm axial resolution.

FIG. 39 is a MAP image of carbon-fiber phantom with 0.5×0.5 mm² area. PA: photoacoustic.

FIG. 40A is a photograph of chick-embryo chorioallantoic membrane (CAM) with imaging area marked by white box.

FIG. 40B is a MAP image of CAM vasculature inside white box of 40A.

FIG. 41 is a photograph of a melanoma phantom.

FIG. 42A is a MAP image of melanin particles detected under mouse skin.

FIG. 42B is a color-coded depth profiling of melanoma phantom. Color bar represents depth relative to skin surface.

FIGS. 43(a) to 43(d) illustrate stages of manufacturing a transparent ultrasound transducer integrated with an optical fiber that is in keeping with embodiments of the disclosure: (a) ITO coated lithium niobate crystal mounted on a glass slide; (b) conductive bonding to brass tubing using silver epoxy (E-solder 5022); (c) filling of the backing layer after fiber insertion and center alignment; and (d) making front- and back-side electrode contacts with a coaxial wire.

FIG. 44 depicts a matching layer according to another embodiment of the present disclosure (a graded index matching layer).

FIG. 45 depicts a transducer according to another embodiment of the present disclosure (having a graded index matching layer).

### DETAILED DESCRIPTION OF THE DISCLOSURE

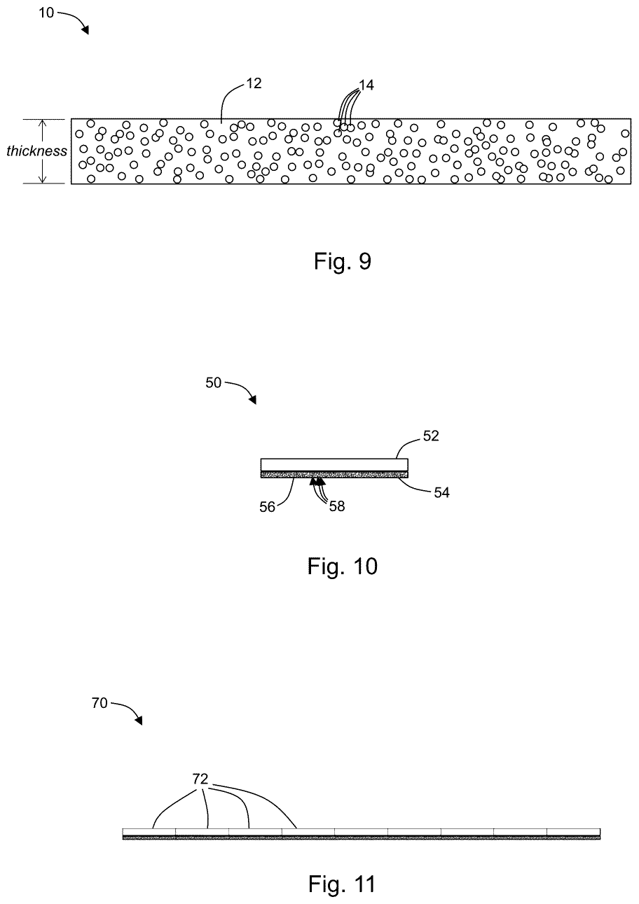

With reference to FIG. 9, in a first aspect, the present disclosure may be embodied as a matching layer 10 for an ultrasound imaging head. The matching layer 10 includes a translucent matrix 12. The translucent matrix 12 may be, for example, a polymer, an epoxy, parylene, glass, quartz glass, and/or the like. In some embodiments, the translucent matrix is optically transparent. The matching layer 10 also includes a plurality of translucent particles 14 disposed in the translucent matrix 12. The plurality of translucent particles may be glass beads (e.g., silicon dioxide/silica SiO2) or other translucent particles (e.g., aluminum oxide, titanium dioxide, cerium oxide, etc.) In some embodiments, each particle of the plurality of translucent particles is optically transparent. In some embodiments, optically transparent materials are transmissive to light (e.g., light having wavelengths in a desired range) without significant scattering.

The particles of the matching layer may be, for example, oxide particles, such as, for example, metal oxides and/or other oxides. Other particles may be used, such as white-colored particles. Although the present disclosure is described in terms of non-limiting embodiments using glass beads, other embodiments within the scope of the present disclosure may utilize other particles such as, for example, oxide particles. Reference to size and/or other characteristics of glass beads also apply to such other particles in other embodiments. In some embodiments, combinations of particle types (materials, morphologies, etc.) may also be used.

The configuration and components of the matching layer are selected to provide a predetermined acoustic impedance. The predetermined acoustic impedance may be an acoustic impedance between that of the transducer (i.e., transducer element) and the target of interest (e.g., biological tissue). In some embodiments, the predetermined acoustic impedance is an impedance approximately halfway between that of the transducer and that of the target of interest (where, in various embodiments, approximately halfway reflects a value within a range of ±5%, ±10%, ±20% of the halfway value). For example, the volume fraction of the plurality of translucent particles in the translucent matrix is selected so as to provide the predetermined acoustic impedance. In another example, the particles of the plurality of particles may be selected to have a diameter which provides the predetermined acoustic impedance. For example, the particles may have a diameter in the range from 1 nm to 50 μm, inclusive (e.g., one or more sizes of 0.001, 0.01, 0.1, 1, 2, 3, 4, 5, 6, 7, 8, 9, 10, 15, 20, 25, 30, 35, 40, 45, 50 μm, or any size or range therebetween). The diameters may be higher or lower than this range. In some embodiments, the particles have a uniform diameter (i.e., each particle has a diameter which is substantially the same as the other particles). In some embodiments, the diameters of the particles may vary within a range (e.g., vary within the range of 1 nm to 50 μm, inclusive or other ranges). In some embodiments, the matching layer has a thickness of ¼ wavelength (e.g., predetermined wavelength in the matching layer of the transducer). One or more of these (and/or other) parameters can be selected so as to provide the predetermined acoustic impedance of the matching layer.

In some embodiments, the translucent matching layer matrix is a graded index matching layer. For example, the matching layer may comprise a stack of two or more transparent matching layer materials mentioned above. For example, a combination of glass or quartz glass combined with glass beads or transparent epoxy or parylene could serve as a graded index matching layer. With reference to FIG. 44, the matching layer 300 may include one or more additional layers 320, each of the one or more additional layers having an additional translucent matrix 322 and an additional plurality of translucent particles 324 disposed in the additional translucent matrix. It should be noted that the translucent matrix 312 and plurality of translucent particles 314 (as described above), may be considered a first translucent matrix and a first plurality of translucent particles (i.e., of a first layer 310). Each additional translucent matrix 322 may be the same as the translucent matrix 312 (i.e., the first translucent matrix) or different from the translucent matrix 312. For example, each additional translucent matrix may be formed of a different material (or have different color, translucency, etc.) as the first translucent matrix. Where there are two or more additional layers, each additional translucent matrix may be the same as or different from the other additional translucent matrixes. In another example, each translucent matrix may be the same as the first translucent matrix. For example, the first translucent matrix and one or more additional translucent matrixes may be monolithic or may be formed as separate matrix thicknesses (i.e., layers).

Each additional plurality of translucent particles 324 may be the same as of different from the plurality of translucent particles 314 (i.e., the first plurality of translucent particles) or different from the plurality of translucent particles 314. For example, each additional plurality of translucent particles may be made from a different material and/or having a different particle size (and/or color, translucency, volume fraction, etc.) from a material and/or particle size of the first plurality of translucent particles and/or a material and/or particle size of any other additional plurality of translucent particles. An overall thickness of each of the one or more additional layers 320 may be the same as or different from a thickness of the first layer 310 (i.e., generally defined by thicknesses of each additional translucent matrix and the translucent matrix, respectively).

An acoustic impedance of each of the one or more additional layers may be different from the acoustic impedance of the first layer. For example, a graded index matching layer may have multiple layers having acoustic impedances which increment between an acoustic impedance of the transducer (e.g., transducer element) and an acoustic impedance of the target of interest (e.g., biological tissue).

With reference to FIG. 10, the present disclosure may be embodied as a transparent ultrasound transducer 50 having a transparent piezoelectric element 52 and a matching layer 54 bonded to the piezoelectric element. The matching layer 54 may be of any of the embodiments described herein. For example, the matching layer 54 includes a translucent matrix 56. The translucent matrix 56 may be, for example, a polymer, an epoxy, and/or the like. In some embodiments, the translucent matrix is optically transparent. The matching layer 54 also includes a plurality of translucent particles 58-such as glass beads (silicon dioxide/silica/SiO2) or other particles (e.g., aluminum oxide, titanium dioxide, cerium oxide, etc.)—disposed in the translucent matrix 56. In some embodiments, each particle of the plurality of particles is optically transparent. The particles of the matching layer may be, for example, oxide particles, such as, for example, metal oxides and/or other oxides. Other particles may be used, such as white-colored particles. Although, for convenience, the present disclosure is described in terms of non-limiting embodiments using glass beads, other embodiments within the scope of the present disclosure may utilize other particles such as, for example, oxide particles. Reference to size and/or other characteristics of glass beads also apply to such other particles in other embodiments. In some embodiments, combinations of particle types (materials, morphologies, etc.) may also be used.

In some embodiments, the transducer is an array, such as a linear array. For example, the transducer may include a plurality of elements (e.g., 64 elements). With reference to FIG. 11, in some embodiments, a transducer array 70 includes a plurality of transducers 72. The plurality of transducers 72 may be configured as disclosed herein. For example, each transducer 72 may have a transparent piezoelectric element and a matching layer bonded to the piezoelectric element. The matching layer may be of any of the embodiments described herein. For example, the matching layer includes a translucent matrix, such as, for example, a polymer, an epoxy, and/or the like. In some embodiments, the translucent matrix is optically transparent. The matching layer also includes a plurality of translucent particles disposed in the translucent matrix. In some embodiments, each particle of the plurality of translucent particles is optically transparent. In some embodiments, the matching layers of each transducer of the transducer array are part of a monolithic matching layer (e.g., formed from a unitary material).

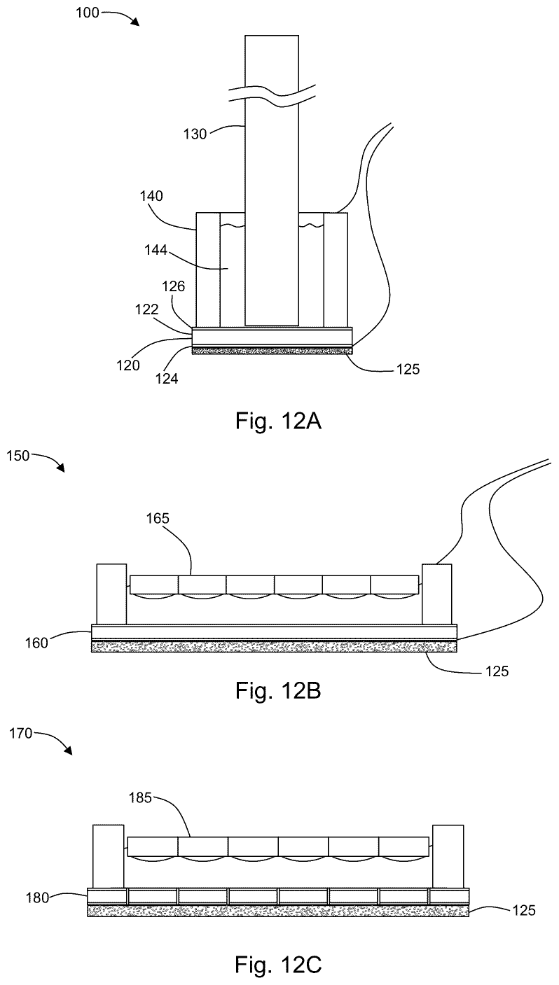

In another aspect, the present disclosure provides photoacoustic-imaging techniques using an optically transparent bulk piezoelectric ultrasound transducer. With reference to FIG. 12A, the present disclosure may be embodied as a device 100 for photoacoustic imaging of a region of interest. The device 100 includes a transparent piezoelectric element 120 for receiving ultrasonic emissions from the region of interest. The device 100 includes a matching layer 125 as disclosed herein. The matching layer 125 is disposed on the transparent piezoelectric element 120. A light source 130 is configured to illuminate the region of interest by transmission at least partially through the transducer 120 and the matching layer 125. It should be noted that the terms “transparent” and “translucent” may be used interchangeably herein to indicate a material which can transmit all or some of a wavelength or range of wavelengths of light. The term “light” is used herein to include any electromagnetic radiation, including but not limited to visible light, ultraviolet, infrared, x-ray, and/or microwave (or portions of such radiation).

The transparent piezoelectric element 120 has a piezoelectric substrate 122. The substrate 122 can be made from any transparent material with piezoelectric properties. For example, the substrate 122 may be made from lithium niobate (LiNbO₃), polyvinylidene fluoride (PVDF), lead magnesium niobate-lead titanate (PMN-PT), piezoelectric composites (e.g., 1-3 composites, etc.) or any other such material or combinations thereof. Lithium Niobate is a versatile optical material used in various photonic applications. A wafer of lithium niobate having polished surfaces shows an optical transparency of more than 80%. 360 Y-cut lithium niobate exhibits good electromechanical coupling coefficient (49%), high acoustic wave velocity (7340 m/s), and low permittivity (39), making it a suitable candidate for use in ultrasound transducers, particularly in receive mode. In crystalline form, LiNbO₃ has a high curie temperature (>11000° C.), which makes it well suited for PAI systems operating at high temperatures. Furthermore, the high acoustic wave velocity is beneficial for use in very high frequency (e.g., >50 MHz) bulk ultrasound transducers. Lithium niobate has also been used for high temperature ultrasound transducers due to its high Curie temperature. PVDF is another transparent piezoelectric material with the added benefit of being more flexible than ceramic material, but it exhibits much lower sensitivity due to lower electromechanical coupling. The transducer may have a thickness suitable for use with ultrasonic waves (responsive to ultrasonic frequencies). For example, as further detailed below in the example embodiments, a 250 μm lithium niobate substrate has a center frequency of approximately 15 MHz. Thinner wafers will be responsive to higher frequencies (e.g., lithium niobate with a thickness of 50 μm or less may be responsive to frequencies of 100-200 MHz). The use of higher frequencies may increase bandwidth and improve spatial resolution. On the other hand, thicker wafers will allow for imaging deeper into the region of interest.

The transducer 120 may further comprise a front electrode 124 in communication with a front surface (front side) of the substrate 122. The term “front” is used herein to indicate a component closest to the subject being imaged, and “back” is used to indicate a component opposite the subject being imaged. The front electrode 124 may be a layer of a transparent conductor on at least a portion of the front surface of the substrate. The transparent conductor may be, for example, indium-tin-oxide (ITO), graphene, a silver nanowire composite (having sparsely spread silver nanowires), a carbon fiber composite, or any other transparent conductive material or combinations of materials. ITO also can be used as an anti-reflective coating on LiNbO₃, thus improving the transparency of the piezoelectric substrate material further. The transducer 120 may further comprise a back electrode 126 in communication with a back surface (back side) of the substrate 122. The back electrode 126 may be a layer of a transparent conductor on at least a portion of the back surface of the substrate, such as, for example, ITO, or other such materials or combinations of materials.

The matching layer 125 may be an acoustic matching layer. The matching layer 125 includes a translucent matrix and a plurality of translucent particles disposed within the translucent matrix. The matching layer may have a thickness of ¼ of a wavelength of the transparent piezoelectric element (i.e., of a design frequency of the transparent piezoelectric element). A volume fraction of the plurality of translucent particles in the translucent matrix is selected to provide a predetermined acoustic impedance. The translucent matrix may be transparent. The translucent matrix may be a polymer or an epoxy.

The particle of the plurality of particles may be transparent. The diameters of the particles of the plurality of particles may be selected such that the matching layer has a predetermined acoustic impedance. For example, in some embodiments, the particles of the plurality of particles may each have a diameter in the range of 5 to 50 pim, inclusive. In some embodiments, the volume fraction of the plurality of translucent particles in the translucent matrix is in the range from 15% to 60%.

Transducers of the present disclosure may be of various sizes. For example, transducers having diameters of less than 2.5 mm, 1 mm, or less, may be suitable for uses such as endoscopy. Embodiments using a TUT for OR-PAM may utilize larger sizes such as 5 mm×5 mm, 10 mm×10 mm, or larger or other sizes between these values. The sizes described herein are intended to be exemplary, and transducers are not limited to these sizes. Transducers may be larger, smaller, or sizes in between the values disclosed here. Transducers may also take on various shapes. For example, a transducer may be round (circular, ovoid, etc.), rectilinear (square, rectangular, etc.), or any other regular or irregular shape as suited for a particular application.

The light source of the device 100 may be an optical fiber 130. Such an optical fiber may receive light at an input end and emit the received light at an output end. For example, the optical fiber 130 may be configured to be coupled to a laser at an input end and to emit light received from the laser at an output end opposite the coupled end. In some embodiments, an output end of the optical fiber is attached to the back side of the transducer and positioned such that light emitted from the output end passes through the transducer to illuminate the region of interest. In some embodiments, the light source comprises one or more lasers, such as, for example, a vertical-cavity surface-emitting-laser (VCSEL). In some embodiments, the light source comprises one or more light-emitting diode (LEDs). Other light sources are known and may be used in the device. Combinations of two or more types of light sources may be used. The light source may emit light having a source wavelength range. For example, the source wavelength range may be 250 nm-2400 nm. In another example, the source wavelength range may be 690-970 nm. Other appropriate ranges will be apparent in light of the present disclosure. A suitable transducer is transparent in the source wavelength range. For example, a suitable transducer may allow at least 30% of light in the source wavelength range to be pass through. In some embodiments, suitable transducers may allow at least 50%, 60%, 70%, 80%, or 90% of light in the source wavelength range to pass through (i.e., transparent/translucent).

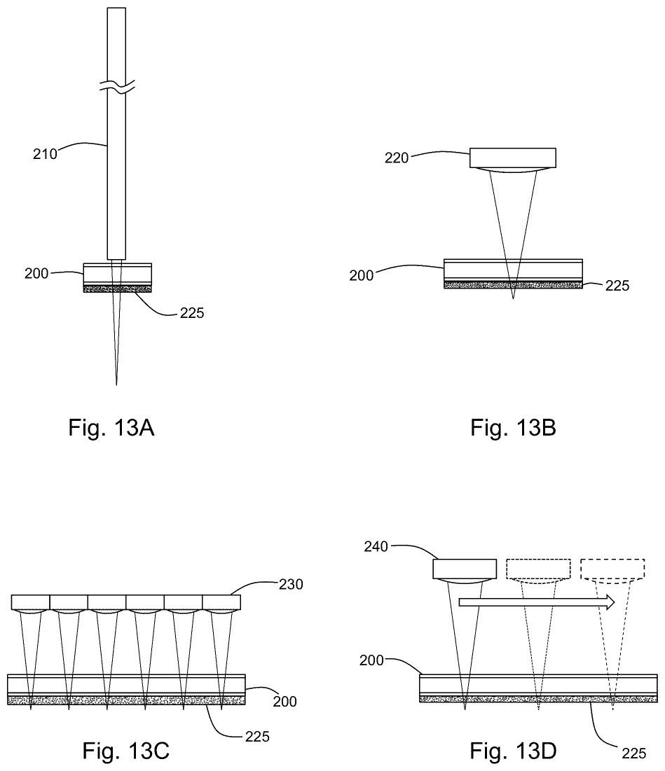

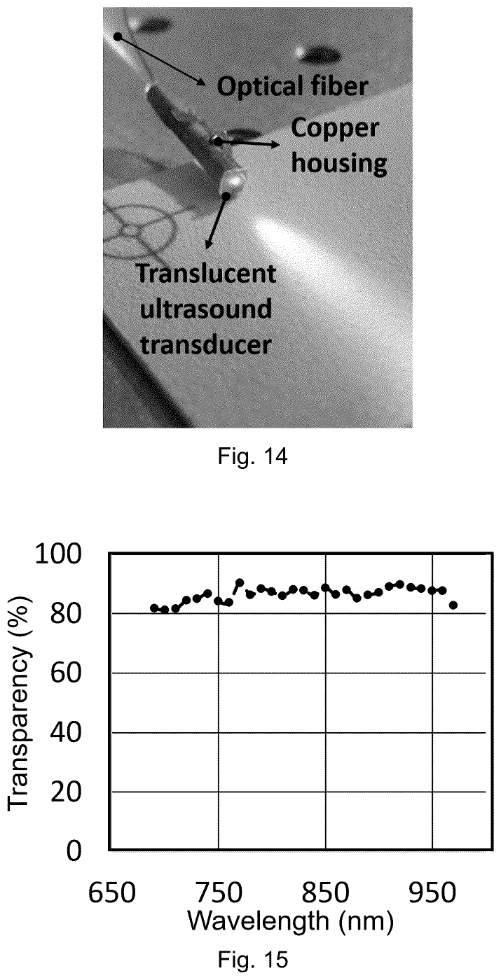

Illumination through the transparent piezoelectric element can be achieved by various systems depending on the application. FIGS. 13A-13D are simplified diagrams showing example arrangements of light sources with respect to a transducer and matching layer. For example, for space-constrained applications, such as, for example, endoscopy, etc., a transparent piezoelectric element 200 can be integrated with an optical fiber 210 (see, e.g., FIG. 13A). FIG. 13B shows a similar embodiment using an LED light source 220. In another arrangement, an arrayed light source 230 (for example, an array of LEDs or the like) can be arranged to illuminate a region of interest through a transparent piezoelectric element 200 and a matching layer 225 (see, e.g., FIG. 13C). In some embodiments, each element of the light source array (or combinations of more than one element) may be activated separately, sequentially, and/or simultaneously, according to the application.

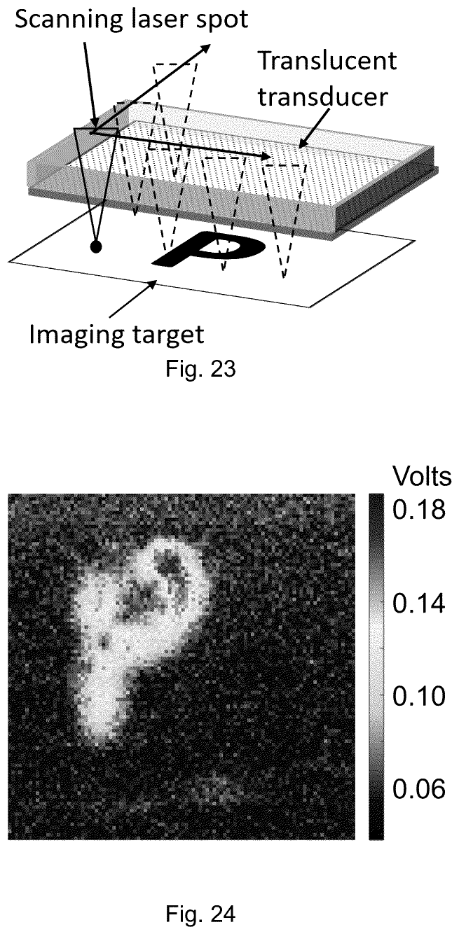

In another embodiment, sometimes referred to as a “window transducer” embodiment, a light source 240 (which may be a single-element light source or a multi-element light source) can be moveable with respect to the transparent piezoelectric element 200 such that the light source 240 can be scanned (e.g., raster scanned) over the transducer to image a region of interest without need to move the transducer. By doing so, unlike in the prior art photoacoustic systems, the optical hardware may be separated from the ultrasound acquisition. This may be advantageous in imaging conditions where other imaging methods need to be applied on the same location. For example, such an embodiment can be used for simultaneous photoacoustic and optical imaging of a region of interest. FIG. 23 describes a system of illumination and imaging for such a transducer. Such embodiments can be advantageous for high-throughput PAI.

The device 100 may comprise a housing 140. The housing 140 may provide structural support for the transducer 120 and/or other components. The housing may be made from any material or combinations of materials suitable for the application. In some embodiments, the housing is made from a metal, such as, for example, brass. In this way, the housing may be arranged to be in contact with an electrode of the transducer and provide a convenient way to connect to the electrode. The housing may also provide an acoustic dampening function by, for example, absorbing reverberations. In this way, bandwidth and sensitivity of the device may be improved.

The device 100 may further comprise a transparent backing layer 144 disposed on the back side of the transducer 120. Such a backing layer 144 may provide dampening to improve bandwidth and sensitivity. The backing layer may be, for example, a transparent epoxy, or any other transparent material or combinations of materials. The bandwidth of a device may be further improved by adding particles, such as tungsten or silver particles, to the backing layer to increase the mass of the dampener. A device may advantageously avoid disposing such particles between the light source and the transducer. Mechanically coupling the light source with the transducer can lead to improved acoustic dampening of acoustic waves received by the substrate.

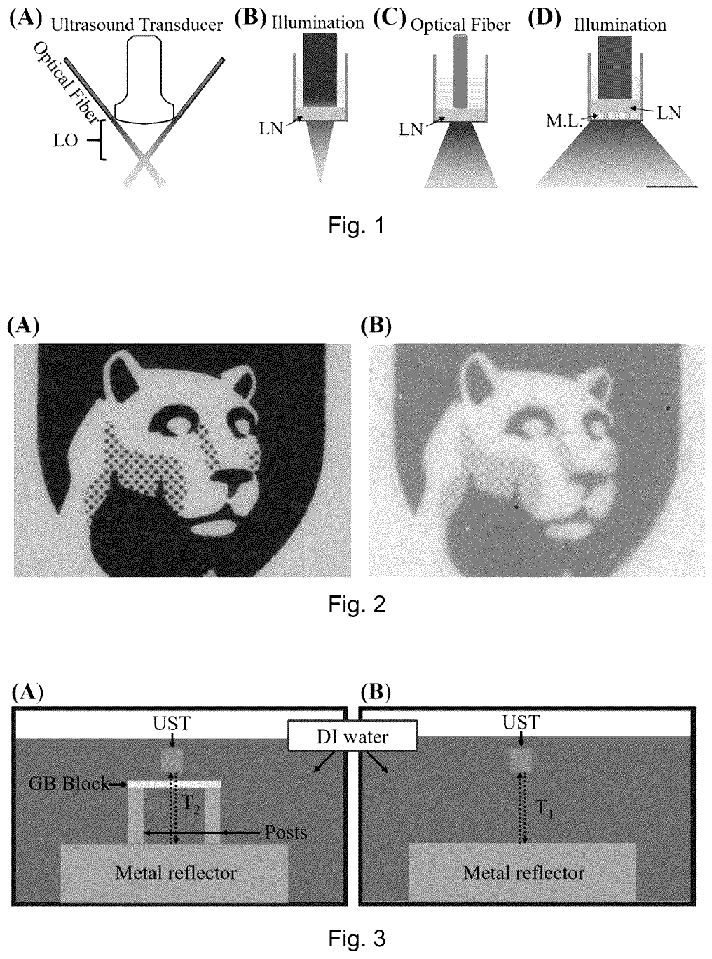

FIG. 12B depicts an embodiment of a device 150 having a single-element transducer 160, an arrayed light source 165, and a matching layer 125. In such an embodiment, one or more elements of the arrayed light source may be energized at the same time and the acoustic response may be detected by the transducer. Then, a different one or more of the elements of the arrayed light source may be energized at the same time and another acoustic response detected. FIG. 1C depicts an embodiment of a device 170 having a multi-element (e.g., arrayed) transducer 180, an arrayed light source 185, and a matching layer 125. In this embodiment, one or more elements of the arrayed light source may be energized at the same time and the acoustic response may be detected by one or more elements of the arrayed transducer. In a particular example, a single element of the light source may be energized, and one or more elements of the transducer may be used to detect the acoustic response.

With reference to FIG. 45, in some embodiments, the present disclosure may be embodied as a transparent ultrasound transducer 350 having a transparent piezoelectric element 352 and a graded index matching layer 354 (similar to that described above with reference to FIG. 44). For example, the matching layer 354 may comprise a stack of two or more transparent matching layers 360, 370 mentioned above. For example, a combination of glass or quartz glass combined with glass beads or transparent epoxy or parylene could serve as a graded index matching layer. The matching layer 354 may include one or more additional layers 370, each of the one or more additional layers having an additional translucent matrix and an additional plurality of translucent particles disposed in the additional translucent matrix. It should be noted that the translucent matrix and plurality of translucent particles, may be considered a first translucent matrix and a first plurality of translucent particles (i.e., of a first layer 360). Each additional translucent matrix may be the same as the translucent matrix (i.e., the first translucent matrix) or different from the translucent matrix. For example, each additional translucent matrix may be formed of a different material (or have different color, translucency, etc.) as the first translucent matrix. Where there are two or more additional layers, each additional translucent matrix may be the same as or different from the other additional translucent matrixes. In another example, each translucent matrix may be the same as the first translucent matrix. For example, the first translucent matrix and one or more additional translucent matrixes may be monolithic or may be formed as separate matrix thicknesses (i.e., layers).

Each additional plurality of translucent particles may be the same as of different from the plurality of translucent particles (i.e., the first plurality of translucent particles) or different from the plurality of translucent particles. For example, each additional plurality of translucent particles may be made from a different material and/or having a different particle size (and/or color, translucency, volume fraction, etc.) from a material and/or particle size of the first plurality of translucent particles and/or a material and/or particle size of any other additional plurality of translucent particles. An overall thickness of each of the one or more additional layers 370 may be the same as or different from a thickness of the first layer 360 (i.e., generally defined by thicknesses of each additional translucent matrix and the translucent matrix, respectively).

An acoustic impedance of each of the one or more additional layers may be different from the acoustic impedance of the first layer. For example, a graded index matching layer may have multiple layers having acoustic impedances which increment between an acoustic impedance of the transducer (e.g., transducer element) and an acoustic impedance of the target of interest (e.g., biological tissue).

In some embodiments, the device may be used for hybrid ultrasound/photoacoustic imaging. In such a device, the transducer may be actuated to provide an excitation signal (e.g., pulse, pulse train, etc.) to the region of interest. The device may include a detector such as an image sensor (e.g., charge-coupled device (CCD), CMOS sensor, etc.) to monitor the region of interest for changes. In some embodiments, the transducer may also be used to receive a resulting ultrasonic emission from the region of interest. In some embodiments, the transducer may include one or more elements for providing ultrasonic excitation to the region of interest and one or more elements for receiving a resulting ultrasonic emission from the region of interest.

Photoacoustic imaging systems manufactured in keeping with the present disclosure may be used for non-invasively imaging light or other electromagnetic absorptions inside a tissue or other material, and distinguishing key absorbents based on their characteristic absorption spectrum over a broad wavelength electromagnetic radiation. For example, the technology may be useful for imaging oxy and de-oxyhemoglobin to map vascular networks of arteries and veins and monitoring hemodynamic activity inside the body.

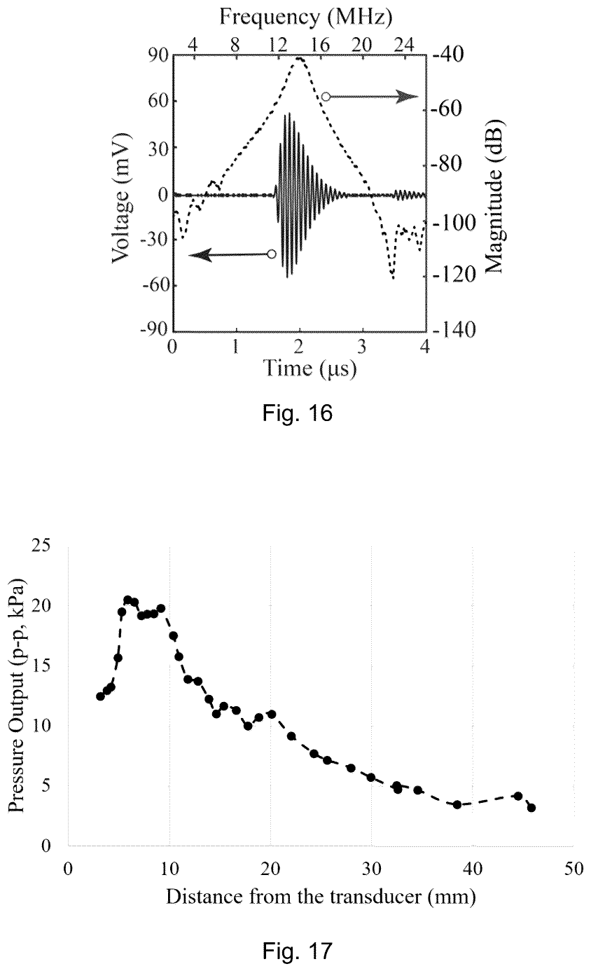

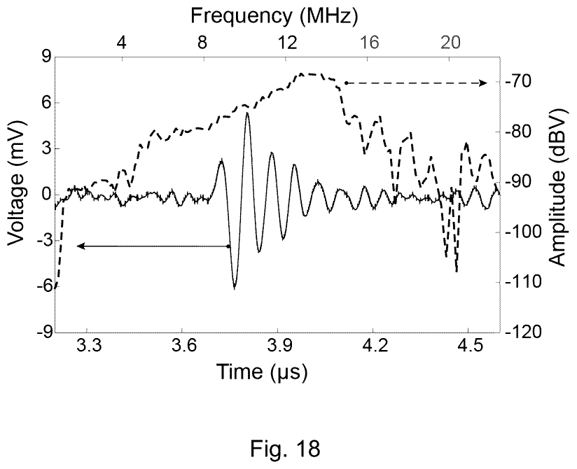

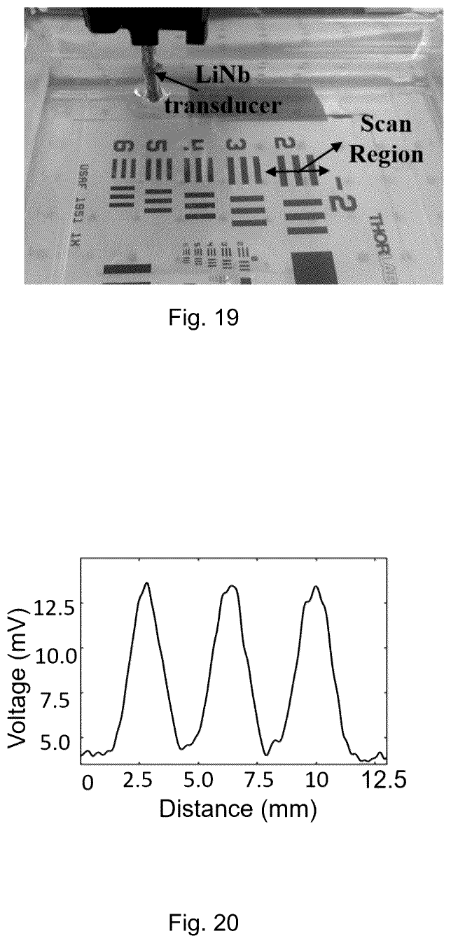

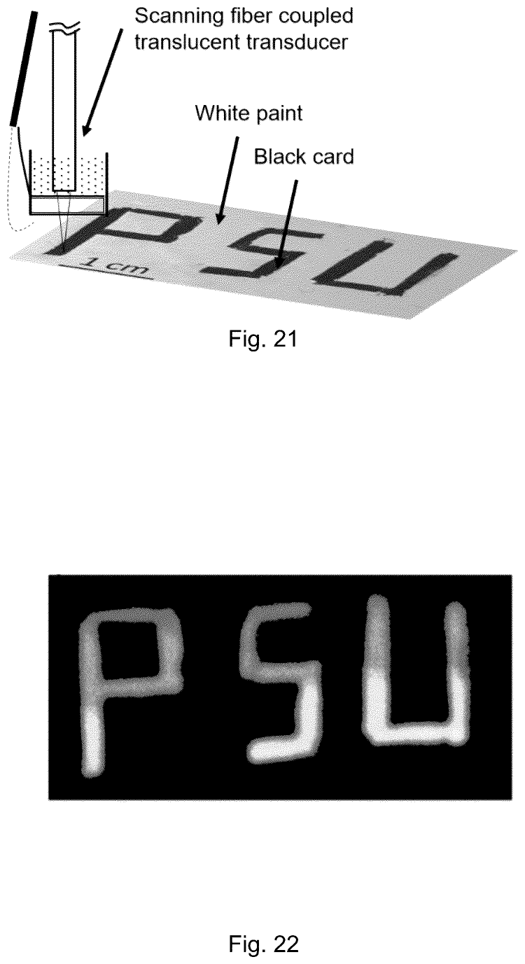

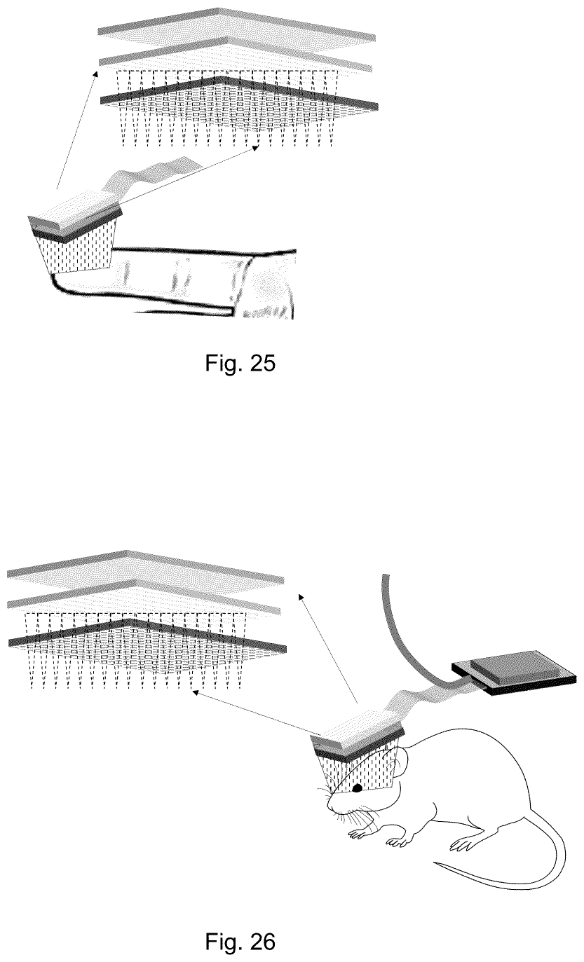

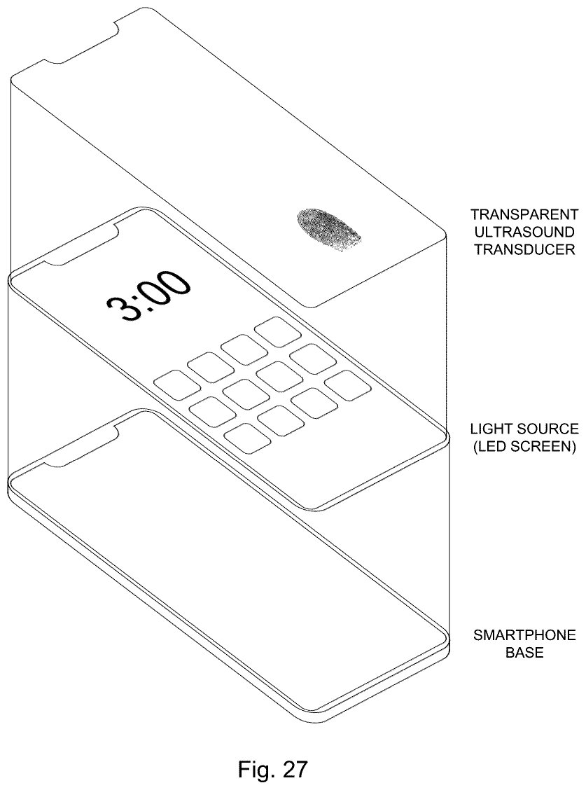

The through transducer illumination system may be used for various photoacoustic imaging applications in different embodiments. For example, a transparent ultrasound transducer can be vertically integrated with an arrayed light source to form a single chip solution for photoacoustic imaging which can be compact or wearable. In an example of a wearable form, a device can be used for biometric sensing applications such as fingerprint capture, for example as illustrated in FIG. 25. Such applications may also use a hybrid ultrasound/photoacoustic imaging approach. In another example, a device can be mounted on the head of a rodent as illustrated in FIG. 26 for frequent monitoring or multi-modal imaging useful in neurovascular research. In another example, a device may be integrated into a system such as a computer, a tablet, a smartphone, etc. to capture biometric information. FIG. 16 shows an example of a smartphone having a transparent ultrasound transducer layer backed by an LED screen as a light source. Such a solution may be used to capture a biometric for user authentication or other functions. In some embodiments, a transparent ultrasound transducer may be operated (e.g., actuated) to excite a region of interest and a detector may be used to monitor the region of interest for changes. For example, in the smartphone embodiment, the transparent ultrasound transducer may be used to excite a fingertip and a cell phone camera or other detector may be used to monitor the fingertip for a response based on the ultrasound excitation.

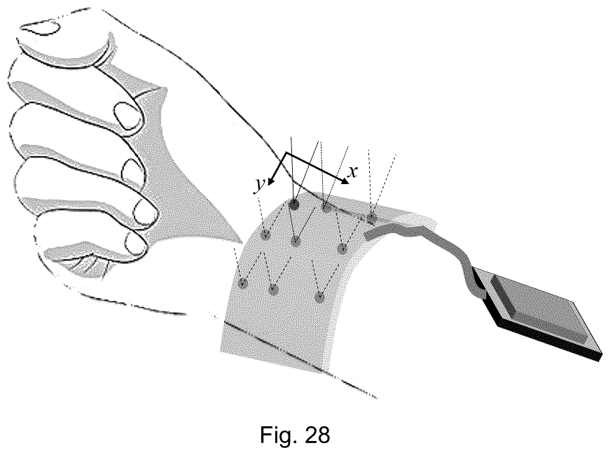

The transducer system shown in FIG. 23 can be particularly useful as a wearable transparent patch that can be placed on a body part. In this way bulky optical systems can be separated from the imaging hardware and one or many focused optical spots can be raster scanned through the transducer to generate photoacoustic images. An example of this embodiment of the invention is illustrated in FIG. 28.

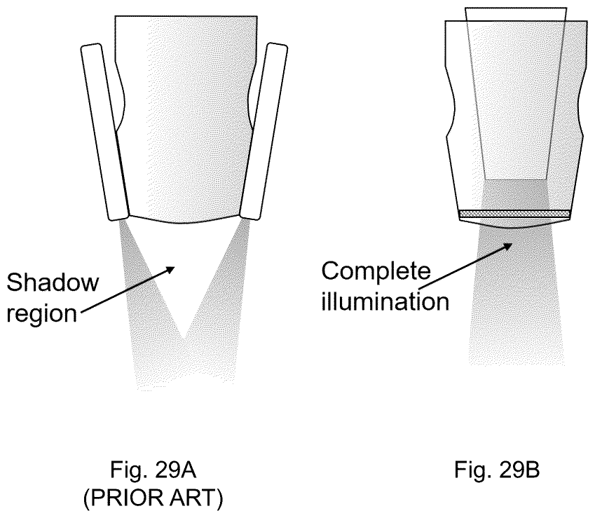

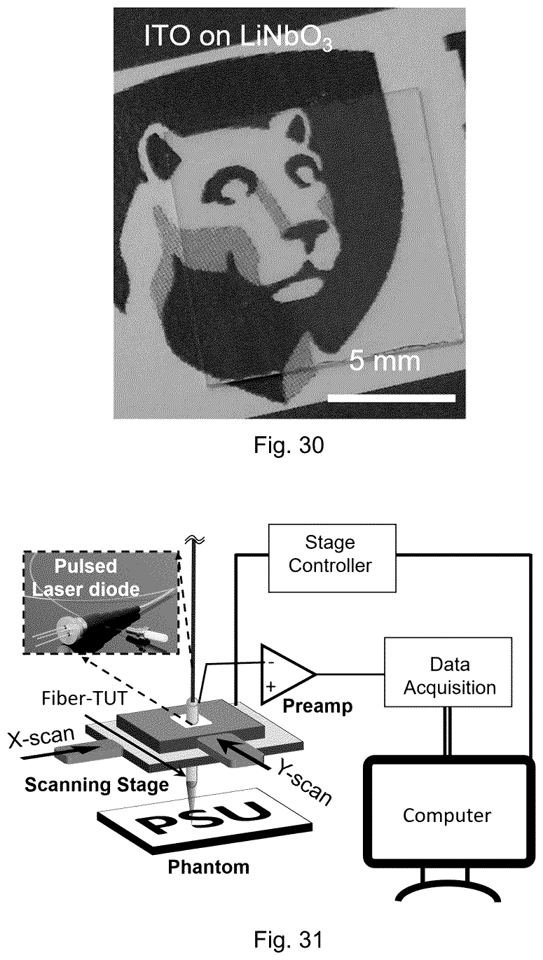

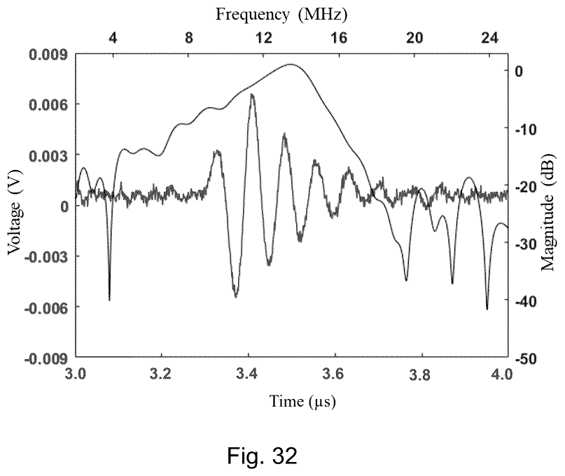

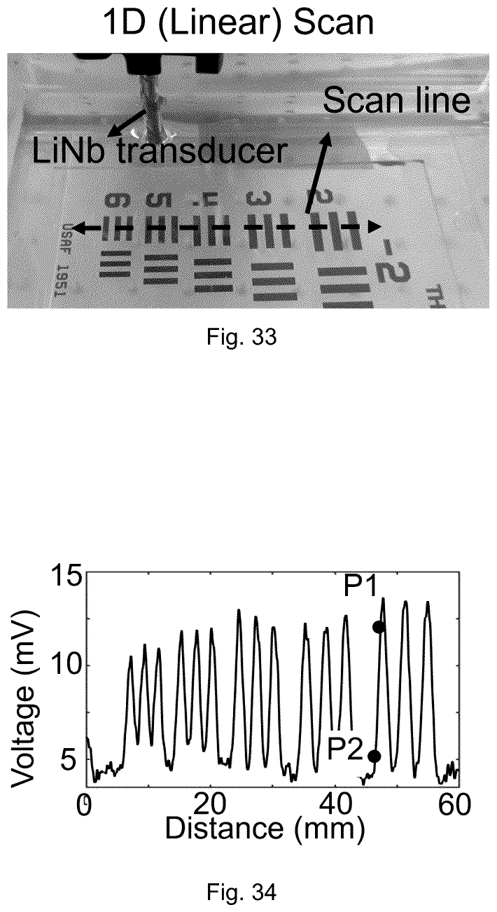

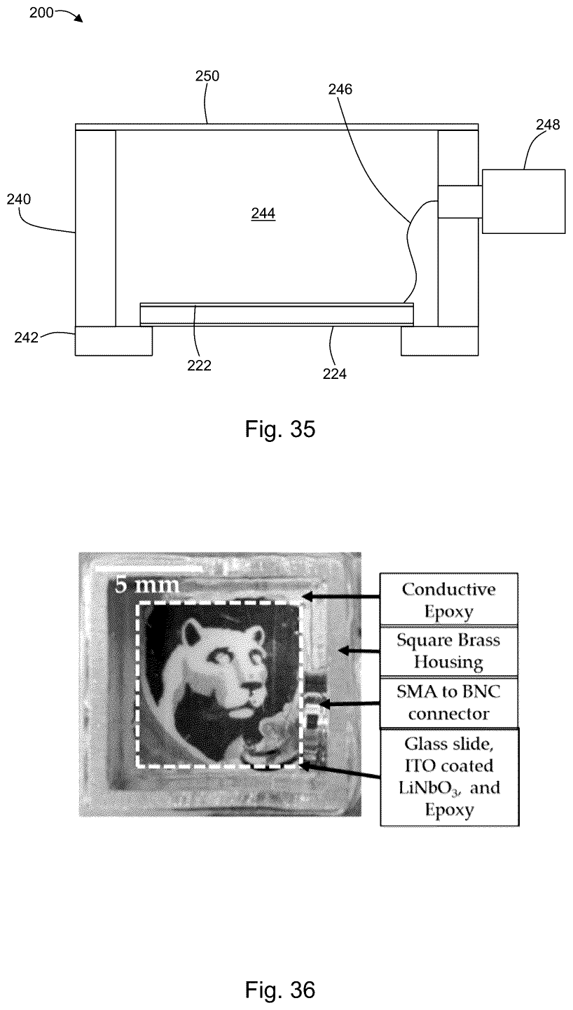

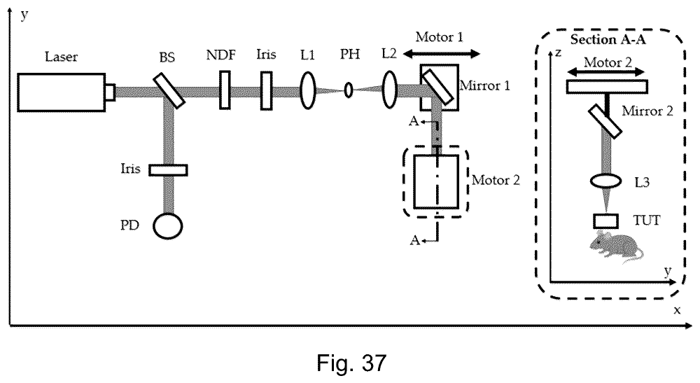

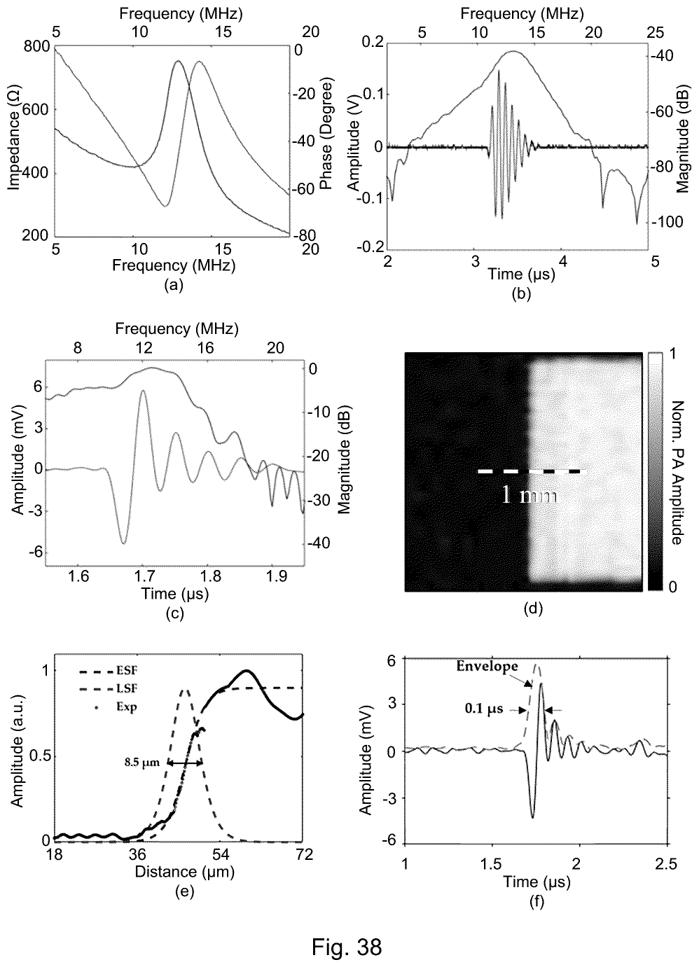

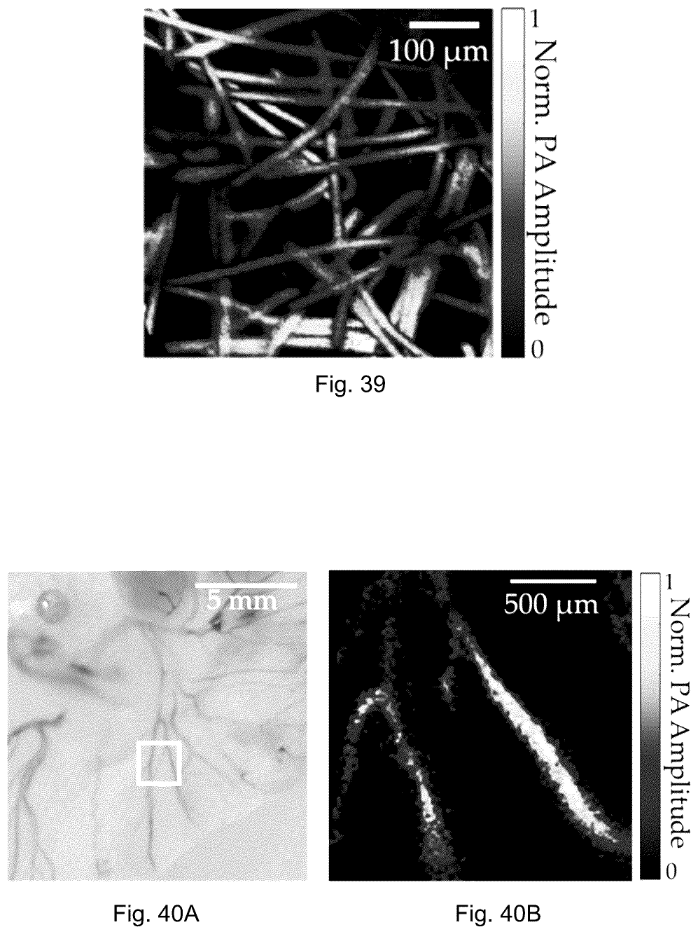

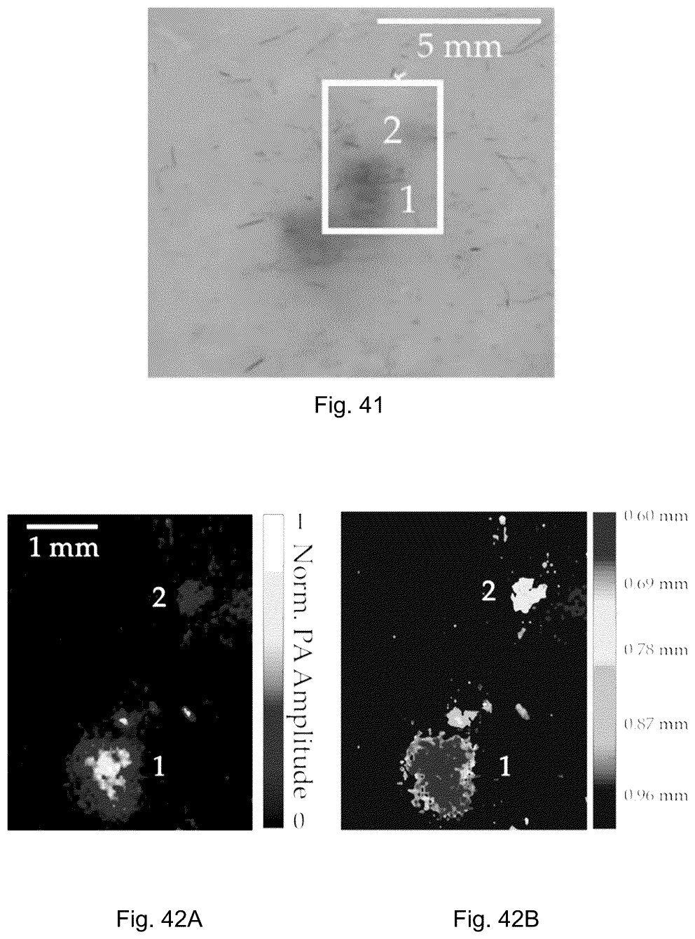

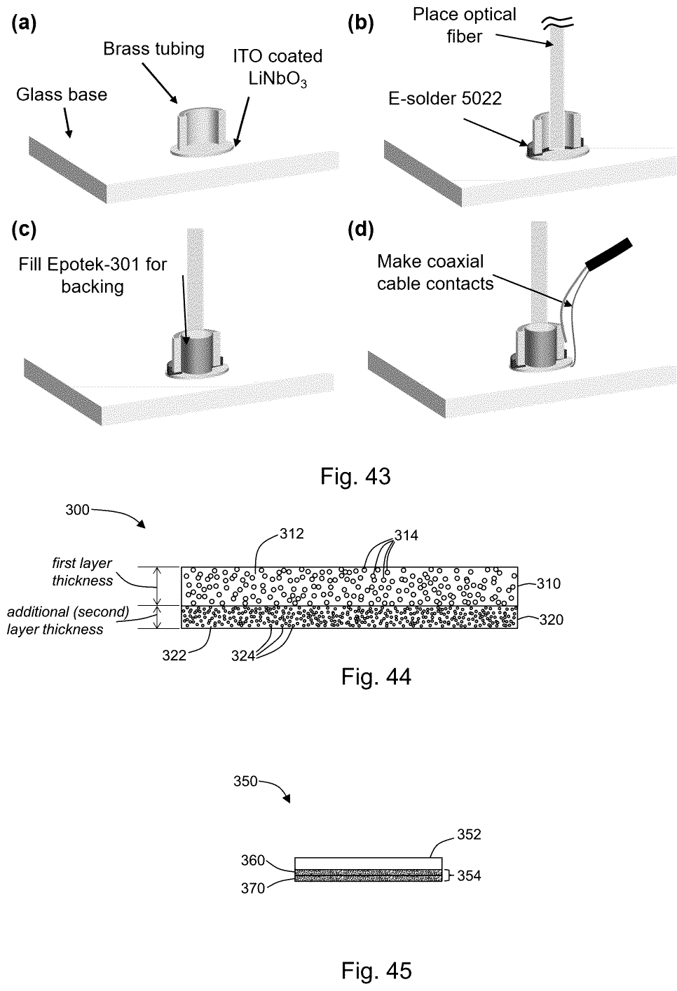

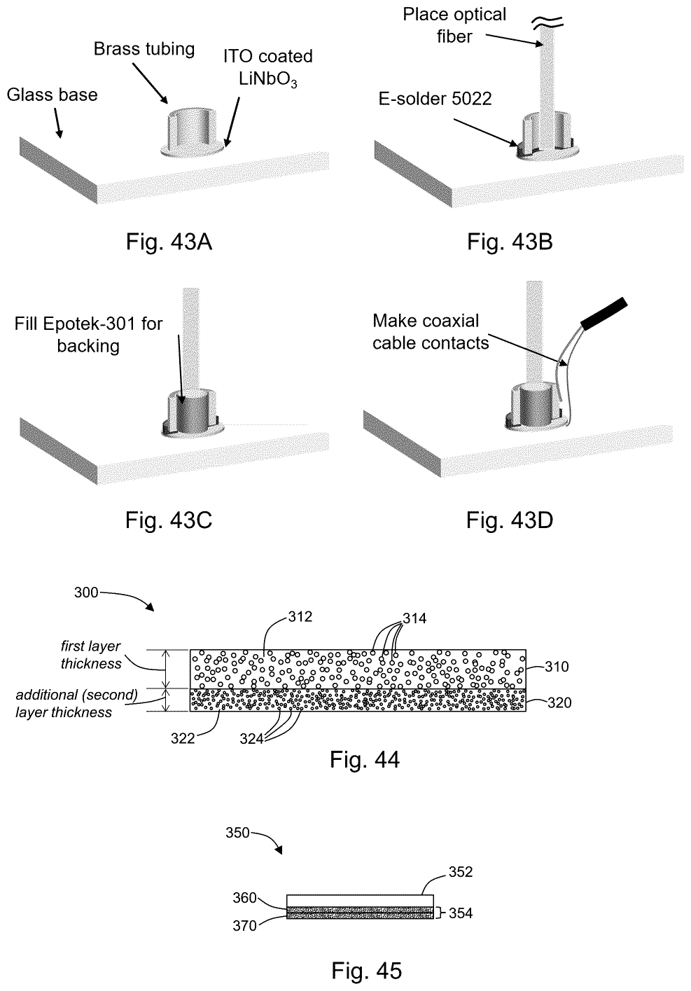

A transparent ultrasound transducer comprising a linear (1D) or 2D array of elements may be packaged with optical fibers illuminating light through the transducer (for example, as illustrated in FIG. 29B), for combined/co-registered ultrasound and photoacoustic imaging. Such a co-registered ultrasound and photoacoustic imaging device may be more compact and capable of providing better field of view without any (or a very small) dark region near the surface of the device. The presently disclosed device can be compatible with convention clinical ultrasound electronics.

Embodiments of the present disclosure are relatively low-cost, easy to manufacture, compatible with commonly used clinical ultrasound electronics, and scalable for different configurations including two-dimensional arrays to achieve real-time three-dimensional photoacoustic imaging. The use of transparent (i.e., translucent) ultrasound transducers allows the transducer to be part of optical system instead of an obstruction to the optics. By doing so, the presently disclosed device may be more compact and portable than prior-art PAI systems.

In another aspect, the present disclosure may be embodied as a method for photoacoustic imaging a region of interest. In such a method, a transparent piezoelectric transducer is provided. A first portion of the region of interest is illuminated through the transducer. The first portion may comprise the entire region of interest or a part of the region of interest. In an example, a light source may be configured to illuminate the first portion of the region of interest by transmitting light through the transparent transducer. The method includes receiving an ultrasonic emission from the first portion of the region of interest, wherein the ultrasonic emission results from the illumination.

The method may further include moving the transducer to a second portion of the region of interest. The second portion of the region of interest is illuminated through the transducer. The method includes receiving an ultrasonic emission from the second portion of the region of interest, wherein the ultrasonic emission results from the illumination. The steps are repeated for additional portions of the region of interest. In this way, the entire region of interest may be imaged. In some embodiments, the second portion of the region of interest is illuminated and a resulting ultrasonic emission is received without moving the transducer. For example, the transducer may be of a size sufficient to image the region of interest without moving the transducer. In such embodiments, a light source may be raster scanned in order to illuminate the second (and additional) portions. In some embodiments, the light source is an array of elements and may be used to illuminate the second (and additional) portions.

In some embodiments, the method may include actuating the transducer to excite at least a portion of the region of interest. It is known that piezoelectric materials can be used as sensors (for example, by detecting a voltage across the material) and/or as actuators (for example, by applying a voltage across the material). In some embodiments, the transducer may be used for hybrid ultrasound/photoacoustic imaging by actuating the transducer to excite at least a portion of the region of interest and receiving an ultrasonic emission resulting from the ultrasonic excitation. In some embodiments, the method may include monitoring the region of interest for changes using a detector, such as an optical detector (e.g., charge-coupled device (CCD), CMOS sensor, etc.)

For convenience, the embodiments of the present disclosure are described in the context of non-limiting embodiments using a lithium niobate transparent ultrasound transducer; however, the present disclosure is not limited to only lithium niobate. The present techniques may be used with other transducers, materials, and configurations. The following is a non-limiting discussion of experiments and example embodiments.

### Example Embodiment-Materials and Methods

### A. GB-LN-TUT Fabrication Process

LN-TUTs with different volume fractions of glass beads as matching layers (GB-LN-TUT) were fabricated using the following steps: Step 1: A 250 μm thick 3″ 36 Y-cut LN wafer (Precision Micro Optics, Burlington, MA, USA) with a designed center frequency of 13 MHz was sputtered on both sides with 200 nm thick indium tin oxide (ITO). Step 2: 3 mm×3 mm squares were diced from the LN wafer using an automatic high precision dicing saw. (K&S 982-6, Giorgio Technology S sales/service, Mesa, AZ, USA). Step 3: The GB sheet was created by mixing spacer glass beads (TPXIII 0.0015″ Max Dia., Potters Industries LLC, Chicago, IL, USA) with a transparent epoxy (Epotek-301, Epoxy Technologies Inc., Billerica, MA, USA) at different volume fractions. To facilitate an even mixture, the epoxy was placed in the oven for 7 minutes until the epoxy became viscous but not hardened, so the glass beads would colloidal suspended in the epoxy during epoxy curing. Then the glass beads were mixed with the epoxy using a vortex for 2 minutes. Step 4: The GB sheet was fabricated by sandwiching the glass beads mixture in between two glass slides. Four 70 μm thick plastic films were placed in between the glass slides to determine the thickness of the GB sheet. Water repellent (rain-x, ITW Global Brands, Houston, TX, USA) was sprayed on the surface of the glass slides to allow easy peeling of the GB sheet. Step 5: After curing, the GB sheet was lapped down to quarter wavelength in the matching layer material. Step 6: To match the size of the LN piezoelectric element, a 3 mm×3 mm GB sheet was cut out using a scalpel blade. Step 7: The GB sheet was then pressed against the LN to act as the matching layer using a custom built presser. The bonding was helped by a small amount of transparent epoxy as the bonding agency. Step 8: The GB coated LN was waxed on a glass slide with the matching layer side down. A micro co-axial wire was then attached to the back electrode of the LN using the conductive silver epoxy (Esolder 3022, Von Roll Isola Inc., New Haven, CT, USA). Then the assembly was placed in the oven for 3 hours at 65 degrees Celsius to cure. Step 9: A 2 mm thick brass tube was placed around the LN and then filled with the transparent epoxy to the top to serve as a backing layer. Then, a 160 μm glass covering was placed on the brass tube to flatten the excess transparent epoxy backing layer. The transducer assembly was left to cure for 24 hours at 25 degrees Celsius as the first curing session, and then the transducer was moved to the oven for 2 hours at 65 degrees Celsius as the second curing session. Step 10: The transducer was then removed from the glass slide and cleaned with isopropyl alcohol. The front electrode of the LN was then connected to the brass tube using the conductive silver epoxy. Step 11: Another micro co-axial wire was attached to the side of the brass tube using the conductive silver epoxy and left to cure in the oven for 3 hours at 65 degrees Celsius.

### B. Acoustic Impedance and Speed of Sound Measurement

The Devaney and Levine model was used to predict the theoretical longitudinal speed of sound of different volume fractions of glass beads in the transparent epoxy. The model calculates the theoretical speed of sound C_{L} by:

$${C}_{L} = \sqrt{\frac{K + \frac{4}{3} G}{ρ}} \qquad ( 1 )$$

where K is the bulk modulus, G is the shear modulus and ρ is the density of the mixture. Theoretical K and G can be calculated by:

$$K = {K}_{1} + {V}_{2} \frac{( 3 K + 4 G ) ( {K}_{2} - {K}_{1} )}{3 K + 4 G + 3 ( {K}_{2} - {K}_{1} )} \qquad ( 2 )$$

$$G = {G}_{1} + {V}_{2} \frac{5 ( 3 K + 4 G ) G ( {G}_{2} - {G}_{1} )}{( 15 K + 20 G ) G + 6 ( K + 2 G ) ( {G}_{2} - {G}_{1} )} \qquad ( 3 )$$

where K₁ and K₂ are the bulk modulus of the transparent epoxy and the glass beads respectively, and G₁ and G₂ are the shear modulus of the transparent epoxy and the glass beads respectively, V₂ is the volume fraction of the glass beads used in the mixture.

The theoretical density p of the glass beads epoxy mixture can be calculated by

$$ρ = {V}_{1} {ρ}_{1} + {V}_{2} {ρ}_{2} \qquad ( 4 )$$

where V₁ and V₂ are the volume fractions of the transparent epoxy and glass beads respectively, and ρ₁ and ρ₂ are the densities of the transparent epoxy and the glass beads respectively.

After calculating the theoretical speed of sound in different volume fractions of glass beads in the transparent epoxy, we experimentally measured the speed of sound in different volume fractions of glass beads by measuring the echo time difference with the presence and the absence of a GB block as shown in FIG. 3.

The detailed description is as follows: Step 1: For the setup, two 18 mm long posts were taped to the metal reflector using double-sided tape. Step 2: A custom made GB block with desired glass beads volume fraction was placed on the top side of the posts using a double-sided tape. Step 3: The setup was placed inside a flat bottom tank filled with deionized water. Step 4: An unfocused flat transducer was mounted on an adjustable mount, excited by an ultrasound pulser receiver (5073-PR, Olympus NDT INC., Waltham, MA, USA). Step 5: The time difference in the pulse-echo signal (transmitted and received by the transducer) with and without the GB block were measured using an oscilloscope as shown in FIG. 3. Using those time differences, the time the sound takes to travel in the GB block is calculated using the following equations:

$${T}_{2} - {T}_{G B} = {T}_{1} - {T}_{w a t e r} \qquad ( 5 )$$

$${T}_{G B} = {T}_{w a t e r} - ( {T}_{1} - {T}_{2} ) \qquad ( 6 )$$

$${T}_{w a t e r} = \frac{2 \cdot {t}_{G B}}{{C}_{W}} \qquad ( 7 )$$

where T_{GB} is the time the sound takes to travel in the GB block. T₁ and T₂ are the measured time differences of the pulse-echo signal detected by the transducer with and without the GB block. t_{GB} is the thickness of the GB block, and C_{W} is the speed of the sound in water, which is 1481 m/s. T_{water} is the time for the sound to travel in water if water had the same thickness as the glass beads block.

Then the speed of sound inside GB block was experimentally calculated using Equation 8:

$${C}_{G B} = \frac{2 \cdot {Thickness}_{G B}}{{T}_{G B}} \qquad ( 8 )$$

The experimental speed of sound for different volume fractions glass beads was plotted against the theoretical speed of sound for the corresponding glass beads epoxy mixture using equation 1.

In addition, the density of the GB block was calculated theoretically and measured experimentally. The sides of the GB block were measured by a digital caliper. Then, the volume of the GB block was calculated by multiplying the length×width×height. Moreover, the mass (m) of the block was measured by a digital scale. The experimental density p of the mixture of the GB block can be calculated by

$$ρ = \frac{m}{V} \qquad ( 9 )$$

The theoretical density of the GB mixture from equation 4 was plotted against the theoretical density of the GB mixture from equation 9.

Furthermore, the theoretical and experimental acoustic impedance were computed and plotted. The acoustic impedance (Z) was calculated using equation 10:

$$Z = ρ \cdot {C}_{L} \qquad ( 10 )$$

The theoretical speed of sound and theoretical density were used to calculate the theoretical acoustic impedance, and the experimental speed of sound and experimental density were used to calculate the experimental acoustic impedance.

### C. Optical Diffusion Measurement

To quantify the optical diffusion capability of the GB sheet, we measured the beam diameter after the light passes through the GB sheet. A highly collimated laser beam (GLPM-10, IPG Photonics; 532 nm wavelength) with a 6.8 mm beam diameter was passed through 3 different volume fractions of GB matching layer sheets, which have the same thicknesses as the matching layers used for the fabrication of the GB-LN-TUTs, and also through a commercial diffuser glass (Ground Glass Diffuser, 100 mm×100 mm, 120 GRIT, Thorlabs Inc., NJ, USA) to compare the light diffusion properties. The 3 matching layers used are 50 μm thickness 15% GB, 60 μm thickness 40% GB and 65 μm thickness 60% GB. The collimated light passed through the GB sheets and the diffused light pattern on a whiteboard placed at 10 cm away from the GB sheet holder was imaged using a phone. The photo was then processed using MATLAB (MATLAB, MathWorks, MA, USA) to estimate the diffused beam diameter on the whiteboard.

Furthermore, we measured the optical transmittance of the GB sheets by a laser photodiode sensor (PD300R-3 W, Ophir-Spiricon, UT, USA) which was placed directly behind the GB sheet. The photodiode sensor was connected to a laser power meter (Centauri Dual Channel, Ophir-Spiricon, UT, USA) for readout.

### D. Pulse-Echo and Photoacoustic A-Line Measurement

As described in earlier work, the two-way ultrasound pulse-echo responses and corresponding frequency characteristics of the GB-LN-TUTs were measured using the ultrasound pulser receiver (Olympus 5073PR, Olympus NDT Inc., Waltham, MA, USA) recording signals from a flat metal target kept inside the water medium.

For the photoacoustic A-line measurements, we used an optical parametric oscillator (OPO) laser source (Phocus Mobile, Opotek, Inc., Carlsbad, CA, USA) at 850 nm with a pulse energy of 100 mJ. The output of this laser was coupled to a custom designed 20 leg optical fiber bundle (Fiberoptic System Inc., Simi Valley, CA, USA). One of the fiber legs was held firm through a silicon rubber and illuminated light through the back of the GB-LN-TUTs into an agar-gel phantom embedded with a light absorbing photoacoustic target, a 0.7 mm diameter pencil lead, kept at 3 mm depth inside the phantom. The generated photoacoustic pressure is sensed by the GB-LN-TUTs and connected to a commercial preamplifier (5073PR, Olympus NDT Inc., Waltham, MA, USA) providing 39 dB gain.

### Results & Discussion

### A. Acoustic Properties of Glass Beads Matching Material

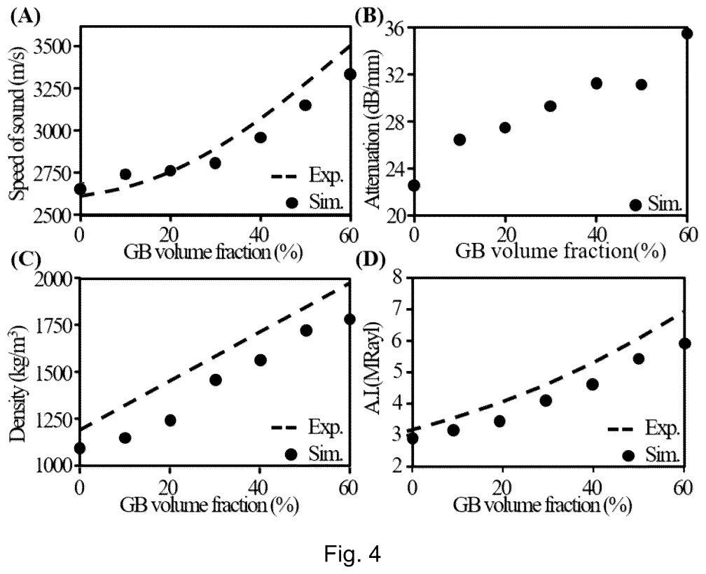

The density, longitudinal speed of sound, acoustic impedance, and acoustic attenuation of eight GB blocks with varying volume fractions of glass beads were theoretically and experimentally measured except for the acoustic attenuation which is only experimentally studied. FIG. 4(A-D) show that increase in the glass beads volume fraction increases density, acoustic impedance, speed of sound, and acoustic attenuation of the GB block. Although, the experimental and theoretical results did not coincide, there is a general consensus between the experimental and theoretical results. For calculating the theoretical speed of sound, we used 5.76 GPa, 1.74 GPa, 40.123 GPa, and 26.42 GPa for K₁, G₁, K₂, and G₂ respectively in equation in equations (2) and (3). The bulk and shear modulus of the glass beads are taken from the company database sheet. Moreover, to optimize the acoustical coupling between the LN piezoelectric material to the tissue loading medium. The acoustic impedance of the matching layer Z₁ is equal to (Zₚ²·Zₗ)^{1/3}, where Zₚ is the acoustic impedance of LN, and Zₗ is the acoustic impedance of the loading medium. Considering the acoustic impedance of LN and the soft tissue are 34, and 1.5 MRayls, respectively, the optimum acoustic impedance needed to couple the LN with the soft tissue is 4.25 MRayls. From FIG. 4B, the closest experimental acoustic impedance value to the optimum is that of the 40% volume fractions GB with 4.62 MRayls. Thus, the 40% GB was chosen as the optimum acoustic matching layer for our LN-TUTs. The acoustic impedance of 15% and 60% GB are below and above the optimum acoustic impedance, respectively. 0% GB (no matching layer) was used as the control to compare the LN-TUTs' performance with the GB-LN-TUTs' performances.

### B. Optical Properties of Glass Beads Matching Material

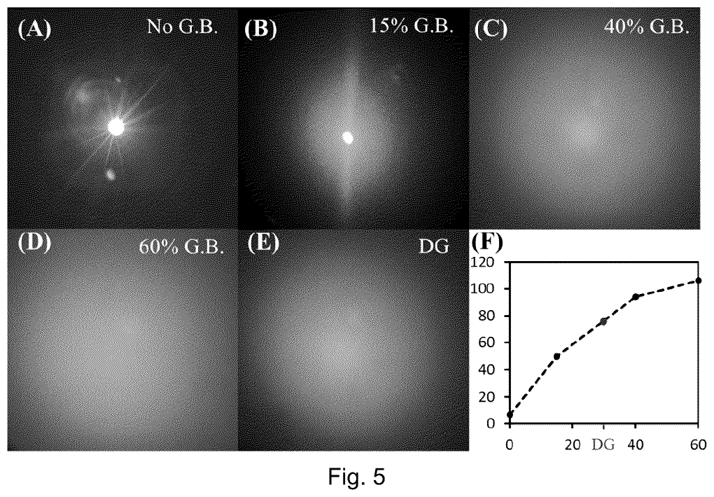

FIG. 5(A-E) show the light distribution and FIG. 5F shows the light power transmission ratio after a collimated light passed through 15%, 40%, 60% GB matching layer sheets and a commercial glass diffuser. FIG. 5A shows the free space collimated light projected on the center of a whiteboard without any scattering, that is without any GB sheet in the light path. The measured light beam diameter is ˜6.8 mm with 0.94 mW light power. FIG. 5B shows the projection of the scattered light beam on the whiteboard after passing through a 50 μm thick 15% GB Matching layer sheet. The diameter of the scattered light beam has increased to ˜5 cm. However, the light after scattering has lost 22.3% of its original power. FIG. 5C shows the projection of scattered light after passing through a 60 μm thickness 40% GB sheet on the whiteboard. The diameter of the scattered light beam is measured to be ˜9.398 cm, indicating more scattering has occurred compared to 15% GB matching layer sheet. The light after scattering has lost 28.7% of its original power. Similarly, as shown in FIG. 5D, a 65 μm thickness 60% GB sheet further increased the light scattering and reduced the light power by 44.7% and increased the beam diameter to ˜10.606 cm. 5E shows the projection of the scattered light on a whiteboard with a measured diameter of ˜7.587 cm after passing through a commercial diffuser glass. Compared to 40% GB, the light beam area is smaller. The new light beam's power after passing through the commercial diffuser glass has lost 39.4% of its original power.

### C. Electrical Characterization Response of GB-TUTs

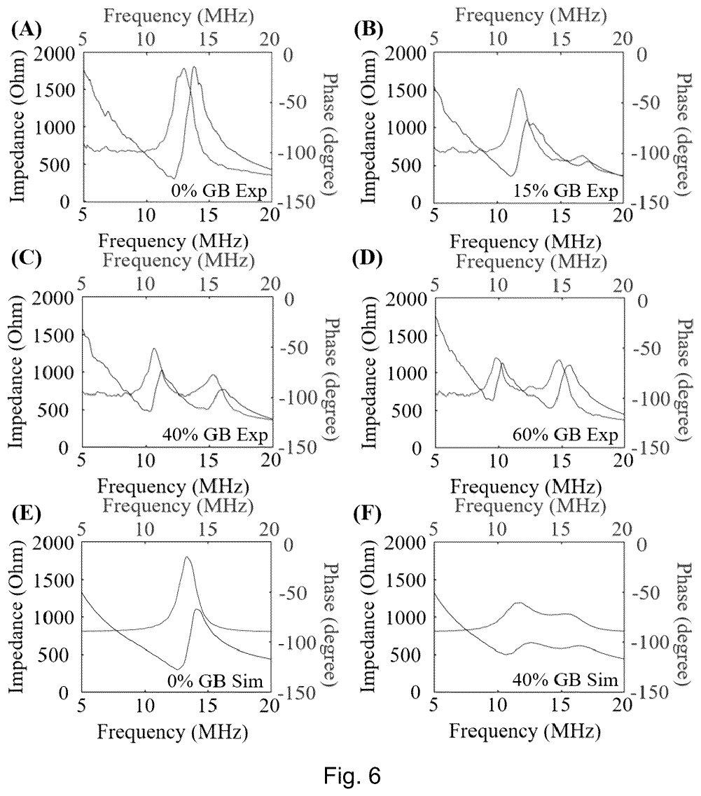

The electrical, acoustic, and photoacoustic characterization results of 15%, 40%, and 60% GB-LN-TUTs were measured and compared with the characterization results of a single element LN-TUT. FIG. 6(A-D) represent the experimental results of the electrical impedance characterization of 0%, 15%, 40%, and 60% GB-LN-TUTs and FIG. 6(E-F) show the simulation results of the electrical impedance characterization for 0%, and 40% GB-LN-TUTs using PiezoCAD (PiezoCAD, Sonic Concepts, Bothell, WA, USA). The LN-TUT's electrical impedance has one resonance (Fr) and anti-resonance (Fa) frequency value of 12.13 MHz and 13.76 MHz, respectively. By integrating GB matching layer to the LN-TUT, a second resonance frequency in the lower frequency side has been introduced, shifting the electrical impedance plot of the TUT to a dual center frequency plot. For example, adding 60% GB matching layer to the LN-TUT, the impedance plot has been altered to a dual center frequency signal with Fr values of 9.34 and 14.11 MHz and Fa values of 10.37 and 15.58 MHz, respectively. The phase change of the simulation result for the electrical impedance of the 0% and 40% GB-LN-TUT are in agreement with corresponding experimental results. While, the experimental electrical impedance results of 0% and 40% GB-LN-TUTs are higher in magnitude than the corresponding simulation results, the experimental and corresponding simulation results follow similar frequency trend. For calculating the experimental electrical impedance, the Fr and Fa frequencies were measured using an impedance analyzer (Agilent E5100A, Keysight Technologies, Inc., Santa Rosa, CA, USA). The electromechanical coupling coefficient (K_{eff}) was calculated using the Fa and Fr based on the IEEE Standard on Piezoelectricity. As shown in Table 1, the K_{eff} for the 0%, 15%, 40% and 60% GB-LN-TUTs are similar with values of 47.11%, 45.15%, 42.76% and 43.59%, respectively.

### D. Acoustic Characterization Response of GB-LN-TUTs

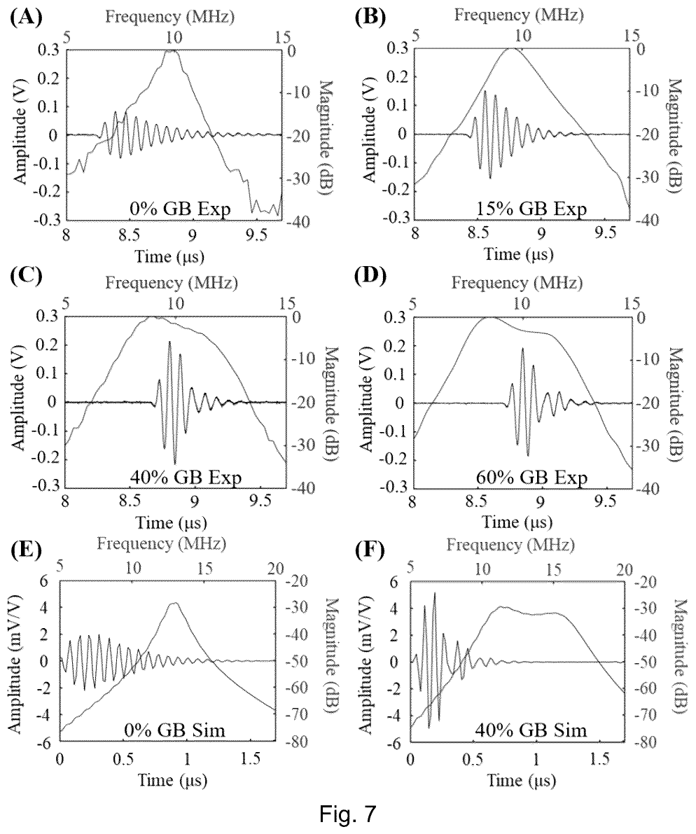

The experimental results of the two-way pulse echo response of 0%, 15%, 40%, and 60% GB-LN-TUTs, respectively, are represented in FIG. 7(A-D). The simulation results of the two-way pulse echo response of 0%, and 40% GB-LN-TUTs are represented in FIG. 7(E-F). The LN-TUT with no GB matching layer showed low pulse-echo sensitivity of 176 mV peak-to-peak amplitude and considerable amount of ringing, leading to a low detection bandwidth of 13.24%. The experimental and simulation pulse-echo results of 0% GB-LN-TUT are in agreement. Similar to the electrical impedance results, adding the GB matching layer to the LN-TUT has not only shifted the center frequency to a lower frequency from 12.28 MHz to 10.43 MHz as the GB content increases to 60% volume fraction, but also introduced a second resonance frequency, widening the range of the −6 dB bandwidth as shown in FIG. 7(A-D). In addition to the bandwidth improvement, the pulse-echo sensitivity also increased with GB concentration, with 15%, 40%, and 60% GB-LN-TUTs showing by 1.75, 2.45, and 2.16 folds improvement to that of the LN-TUT, that is with no GB matching layer. However, there is an anomaly in the pulse echo sensitivity of the 60% GB-LN-TUT, which showed 12% lower pulse-echo amplitude than that of the 40% GB-LN-TUT. It is believed that this reduction in the pulse-echo amplitude is due to a thicker than 2 μm transparent epoxy layer which bonds the matching layer with the LN surface. Ideally the simulation and experimental results of the 40% GB-LN-TUT should be in agreement. However, the second peak in the pulse-echo plot in the 40% GB-LN-TUT experimental results is lower than that of the simulation results.

### E. Photoacoustic A-Line Signal Response of GB-TUTs

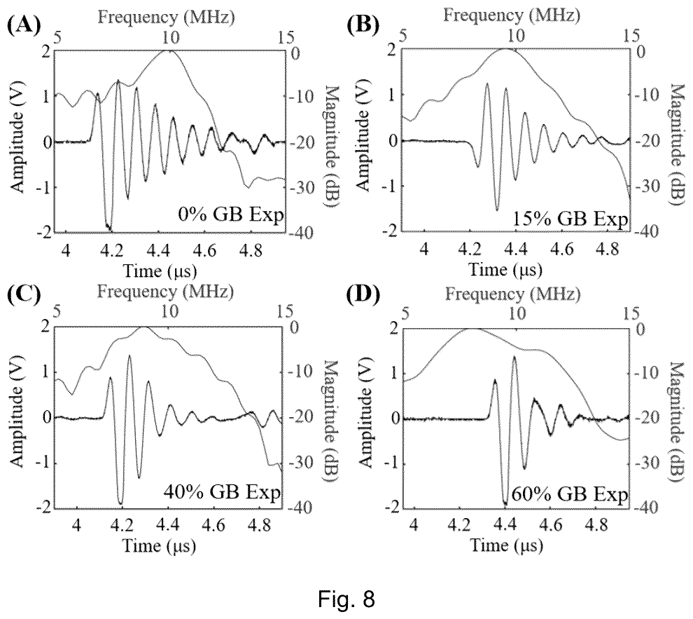

The experimental photoacoustic (PA) A-line response of 0%, 15%, 40%, and 60% GB-LN-TUTs are presented in FIG. 8(A-D), respectively. Notably, the photoacoustic amplitude of all transducers was approximately 3.26 V at 39 dB gain. However, similar to the two-way pulse echo response, adding the GB matching layer to the TUT has not only shifted the center frequency to a lower frequency, but also introduced a second resonance frequency, widening the range of the −6 dB bandwidth. From FIG. 8A, there is abundance of ringing in the photoacoustic plot of the LN-TUT's causing a low photoacoustic bandwidth of 21.78%. By adding the 60% GB matching layer to the LN-TUT, the PA bandwidth has improved 2.93 folds that of the LN-TUT allowing the transducer to capture more signals which will improve the photoacoustic sensitivity.

Table I shows the electrical, acoustic, and photoacoustic characterization results. As shown in Table I, the center frequency of the 0% GB-LN-TUT has shifted from 12.28 MHz to 10.43 MHz as the GB content increases to 60% volume fraction. The electromechanical coupling coefficient is roughly similar for all GB-LN-TUTs. Moreover, the two-way pulse-echo amplitude of the 40% GB-LN-TUT has increased by 2.45 folds that of 0% GB-LN-TUT with no matching layer. However, the 60% GB-LN-TUT's pulse echo sensitivity has dropped to 1.95 folds better than that of LN-TUT. Although there was a drop in the pulse echo sensitivity of the 60% GB-LN-TUT, the pulse echo bandwidths of these 0% GB-LN-TUTs increased as the GB content increased, with 60% GB-LN-TUT showing 4.26 folds better than that of the 0% GB-LN-TUT with no matching layer. For photoacoustic A-line responses, the peak-to-peak amplitude of all the GB-LN-TUTs is around 3.28 V after 39 dB gain from the pulse amplifier. This is because, the light intensity decreases and becomes more uniform with increase in GB concentration, whereas the acoustic sensitivity increases with increase in GB concentration. However, the photoacoustic bandwidth of the 60% GB-LN-TUT is 2.93 folds better than that of the 0% GB-LN-TUT.

TABLE I
GB-TUT Performance Comparison

| GB-TUT | 0% | 15% | 40% | 60% |
|---|---|---|---|---|
| Matching layer thickness (μm) | 0 | 50 | 60 | 65 |
| Fᵣ (MHz) | 12.13 | 11.24 | 10.22 | 9.34 |
| Fₐ (MHz) | 13.76 | 12.60 | 11.30 | 10.37 |
| K_{eff} (%) | 47.11 | 45.15 | 42.76 | 43.59 |
| Center Frequency (MHz) | 12.28 | 11.93 | 11.23 | 10.7 |
| Pulse Echo Amplitude (mV) | 176 | 308 | 432 | 380 |
| Pulse Echo Bandwidth (%) | 13.24 | 22.43 | 43.43 | 50.78 |
| PA Amplitude (V) | 3.32 | 3.28 | 3.20 | 3.24 |
| PA Bandwidth (%) | 21.78 | 31.25 | 51.96 | 63.81 |

Although the present disclosure has been described with respect to one or more particular embodiments, it will be understood that other embodiments of the present disclosure may be made without departing from the spirit and scope of the present disclosure.

What is claimed is:

1. A matching layer for an ultrasound imaging head, comprising:
a translucent matrix; and
a plurality of translucent particles disposed in the translucent matrix; and
wherein a volume fraction of the plurality of translucent particles in the translucent matrix is selected to provide a predetermined acoustic impedance.

2. The matching layer of claim 1, wherein the translucent matrix is transparent and each particle of the plurality of translucent particles is transparent.

3. The matching layer of claim 1, wherein the translucent matrix comprises a polymer or an epoxy.

4. The matching layer of claim 1, wherein each particle of the plurality of translucent particles has a diameter in the range from 1 nm to 50 μm, inclusive.

5. The matching layer of claim 1, wherein the volume fraction of the plurality of translucent particles in the translucent matrix is in the range from 15% to 60%, inclusive.

6. The matching layer of claim 1, wherein the matching layer has a thickness of ¼ of a predetermined wavelength of an ultrasound transducer.

7. The matching layer of claim 1, wherein the matching layer further comprises one or more additional layers, each of the one or more additional layers having:
an additional translucent matrix; and
an additional plurality of translucent particles disposed in the translucent matrix.

8. A transparent ultrasound transducer, comprising:
a transparent piezoelectric element for receiving ultrasonic emission from a region of interest; and
a matching layer disposed on the transparent piezoelectric element, the matching layer comprising:
a translucent matrix; and
a plurality of translucent particles disposed within the translucent matrix; and
wherein a volume fraction of the plurality of translucent particles in the translucent matrix is selected to provide a predetermined acoustic impedance.

9. The transparent ultrasound transducer of claim 8, further comprising a light source configured to illuminate the region of interest, wherein the illumination is provided at least partially through the transparent piezoelectric element and the matching layer.

10. The transparent ultrasound transducer of claim 8, wherein the translucent matrix is transparent, and the plurality of translucent particles is transparent.

11. The transparent ultrasound transducer of claim 8, wherein the translucent matrix comprises a polymer or an epoxy.

12. The transparent ultrasound transducer of claim 8, wherein each particle of the plurality of translucent particles has a diameter selected to provide the predetermined acoustic impedance.

13. The transparent ultrasound transducer of claim 8, wherein each particle of the plurality of particles has a diameter in the range from 1 nm to 50 μm, inclusive.

14. The transparent ultrasound transducer of claim 8, wherein the volume fraction of the plurality of translucent particles in the translucent matrix is in the range from 15% to 60%.

15. The transparent ultrasound transducer of claim 8, wherein the matching layer has a thickness of ¼ of a wavelength of the piezoelectric element.

16. The transparent ultrasound transducer of claim 8, wherein the predetermined acoustic impedance is between the acoustic impedance of the piezoelectric element and the acoustic impedance of a target tissue.

17. The transparent ultrasound transducer of claim 8, wherein the matching layer further comprises one or more additional layers, each of the one or more additional layers having:
an additional translucent matrix; and
an additional plurality of translucent particles disposed in the translucent matrix.

18. A method of impedance matching of an ultrasound transducer, comprising:
applying a translucent matrix to an ultrasound transducer, the translucent matrix having a plurality of translucent particles disposed therein, and wherein a volume fraction of the plurality of translucent particles in the translucent matrix is selected to provide a predetermined acoustic impedance.

19. The method of claim 18, wherein the translucent matrix is transparent and each particle of the plurality of translucent particles is transparent.

20. The method of claim 18, wherein the translucent matrix comprises a polymer or an epoxy.

21. The method of claim 18, wherein each particle of the plurality of particles has a diameter in the range from 1 nm to 50 μm, inclusive.
